(19) United States
(12) Patent Application Publication
(10) Pub. No.: US 2023/0303825 A1
(43) Pub. Date: Sep. 28, 2023

(54) PROCESS FOR PRODUCING POLYESTER ARTICLE

(71) Applicant: Covation Inc., Newark, DE (US)

(72) Inventors: Paul Joseph FAGAN, Wilmington, DE (US); Andrew Jay DUNCAN, Wilmington, DE (US)

(21) Appl. No.: 18/121,306

(22) Filed: Mar. 14, 2023

Related U.S. Application Data
(63) Continuation of application No. 16/095,538, filed on Oct. 22, 2018, now abandoned.

(51) Int. Cl. C08L 67/02; B29C 49/00; B65B 3/00; B65B 3/02; B29L 31/00; B29K 67/00

(52) U.S. Cl. CPC C08L 67/02; B29C 49/0005; B65B 3/003; B65B 3/022; B29K 2067/003; B29L 2031/7158; C08L 2201/14; C08L 2203/10; C08L 2205/025

(57) ABSTRACT

The disclosure relates to processes for producing lightweight polyethylene terephthalate articles such as bottles that retain good batTier properties against the permeation of oxygen, carbon dioxide and/or water vapor. The use of relatively small amounts of polytrimethylene furandicm·boxylate during the formation of the PET bottles can produce a bottle having the required barrier properties and result in the use of less material.

### CROSS REFERENCE TO RELATED APPLICATIONS

This application claims the benefit of U.S. Provisional Application No. 62/326,969 filed Apr. 25, 2016, which is incorporated herein by reference in its entirety.

### FIELD OF THE DISCLOSURE

The present disclosure is directed towards processes for forming polyester shaped articles, for example, articles used for packaging such as thermoformed articles, flexible or rigid films or sheets, containers such as bottles, and preforms that can be used to make the bottles. In particular, the disclosure relates to the formation of polyesters comprising a mixture of both polyethylene terephthalate and polytrimethylene furandicarboxylate.

### BACKGROUND OF THE DISCLOSURE

Barrier properties can be a desired property for polymers used in packaging applications to protect the contents and provide desired shelf-life. Such packaging applications where barrier properties may be desired include for example packaging for food products, personal care products, pharmaceutical products, household products, and/or industrial products. The prevention of oxygen permeation into the product (e.g., oxygen from outside the packaging), for example inhibits oxidation and microbial growth, whereas prevention of permeation of gases contained inside a product such as carbon dioxide used in carbonated beverages can lengthen the shelf-life of a product. Many polymers have emerged for these applications such as poly(ethylene terephthalate) (PET), polyethylene (PE), poly(vinyl alcohol) (PVOH), ethylene vinyl alcohol polymer (EvOH), poly(acrylonitrile) (PAN), poly(ethylene naphthalene) (PEN), polyamide derived from adipic acid and meta xylylene diamine (MXD6) and poly(vinylidene chloride) (PVDC), and may include additives to enhance barrier properties. However, most of these polymers suffer from various drawbacks. For example, both high density polyethylene (HDPE) and low density polyethylene (LDPE) have fair water vapor barrier, but poor oxygen barrier. EVOH exhibits good oxygen barrier at low humidity levels but fails at high levels of humidity. PET has relatively high tensile strength but is limited by low gas barrier properties.

Hence, there is a need for polymer containing articles with improved or comparable gas barrier properties for gases (such as oxygen, and/or carbon dioxide) and/or moisture barrier properties where such polymer containing articles have one or more benefits such as having i) reduced weight, ii) environmental sustainability, iii) reduced material consumption, and/or iv) materials promoting recyclability.

### SUMMARY OF THE DISCLOSURE

The present disclosure relates to a process for reducing the weight of a polyethylene terephthalate (PET) article comprising:
a) replacing in the range of from 1% to 40% by weight of the polyethylene terephthalate with polytrimethylene furandicarboxylate (PTF);
   wherein the PET/PTF article has an oxygen permeation rate, a carbon dioxide permeation rate and/or a water permeation rate that is less than or equal to an identically shaped article consisting of polyethylene terephthalate polymer and weighing 1.05 to 2.00 times or in some embodiments 1.05 to 1.54 times the weight of the PET/PTF article; where the degree of transesterification of the polyethylene terephthalate and the polytrimethylene furandicarboxylate is in the range of from 0.1 to 99.9%.

In some embodiments, the PET article is used for packaging. Examples of packaging articles include but are not limited to, a container, such as a bottle, a preform used to make a bottle, or a thermoformed article formed from a sheet. Other examples of packaging articles include a film or sheet, such as for example i) a single flexible film layer consisting of, or comprising the transesterified PET/PTF composition or a multilayered flexible film where at least one layer of the multilayered flexible film consists of, or comprises the transesterified PET/PTF composition or ii) a single rigid sheet layer consisting of, or comprising the transesterified PET/PTF composition or a multilayered rigid sheet where at least one layer of the multilayered sheet consists of, or comprises the transesterified PET/PTF composition.

The disclosure also relates to a process for reducing the weight of a polyethylene terephthalate (PET) bottle comprising:
b) replacing in the range of from 1% to 40% by weight of the polyethylene terephthalate with polytrimethylene furandicarboxylate (PTF);
   wherein the PET/PTF bottle has an oxygen permeation rate, a carbon dioxide permeation rate and/or a water permeation rate that is less than or equal to an identically shaped bottle consisting of polyethylene terephthalate polymer and weighing 1.05 to 2.00 times, or in some embodiments 1.05 to 1.54 times, the weight of the PET/PTF bottle;
   wherein the degree of transesterification of the polyethylene terephthalate and the polytrimethylene furandicarboxylate is in the range of from 0.1 to 99.9%; and wherein the bottle has an areal stretch ratio in the range of from 5 to 30, or in some embodiments from 5 to 25.

In some embodiments, the PET/PTF bottle is used to contain food (such as a beverage), a personal care product, a pharmaceutical product, a household product or an industrial product, or is a preform which is used to make the aforementioned bottle.

The disclosure also relates to a process for reducing the weight of a polyethylene terephthalate (PET) bottle comprising:
a) blowing a preform to form a bottle;
   wherein the preform comprises in the range of 60% to 99% by weight of polyethylene terephthalate and 1% to 40% by weight of polytrimethylene furandicarboxylate and wherein the bottle has a degree of transesterification between the polyethylene terephthalate and the polytrimethylene furandicarboxylate that is in the range of from 0.1 to 99.9%; wherein the oxygen permeation rate, the carbon dioxide permeation rate and/or the water vapor permeation rate is less than or equal to an identically shaped bottle consisting of PET polymer and having a weight that is 1.05 to 2.00 times, or in some embodiments 1.05 to 1.54 times, the weight of the PET/PTF bottle; and wherein the areal stretch ratio of the bottle is in the range of from 5 to 30, or in some embodiments from 5 to 25.

The present disclosure also relates to a process comprising:
a) heating a mixture comprising 1% to 40% by weight of polytrimethylene furandicarboxylate and 60% to 99% by weight of polyethylene terephthalate to form a polymer melt, wherein the percentages by weight are based on the total weight of the polymer melt; and
b) forming a preform from the melt, wherein:
   the degree of transesterification between the polyethylene terephthalate and the polytrimethylene furandicarboxylate is in the range of from 0.1 to 99.9%.

### DETAILED DESCRIPTION OF THE DISCLOSURE

The disclosures of all cited patent and non-patent literature are incorporated herein by reference in their entirety.

As used herein, the term “embodiment” or “disclosure” is not meant to be limiting, but applies generally to any of the embodiments defined in the claims or described herein. These terms are used interchangeably herein.

Unless otherwise disclosed, the terms “a” and “an” as used herein are intended to encompass one or more (i.e., at least one) of a referenced feature.

When an amount, concentration, value or parameter is given as either a range or a list of upper values and lower values, this is to be understood as specifically disclosing all ranges formed from any pair of any upper and lower values within the range, regardless of whether the ranges are separately disclosed. For example, when a range of “1 to 5” is recited, the recited range should be construed as including any single value within the range or as any values encompassed between the ranges, for example, “1 to 4”, “1 to 3”, “1 to 2”, “1 to 2 & 4 to 5”, “1 to 3 & 5”. Where a range of numerical values is recited herein, unless otherwise stated, the range is intended to include the endpoints thereof, and all integers and fractions within the range.

The features and advantages of the present disclosure will be more readily understood, by those of ordinary skill in the art from reading the following detailed description. It is to be appreciated that certain features of the disclosure, which are, for clarity, described above and below in the context of separate embodiments, may also be provided in combination in a single element. Conversely, various features of the disclosure that are, for brevity, described in the context of a single embodiment, may also be provided separately or in any sub-combination. In addition, references to the singular may also include the plural (for example, “a” and “an” may refer to one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including each and every value between the minimum and maximum values.

As used herein:

“Polyethylene terephthalate” or “PET” means a polymer comprising repeat units derived from ethylene glycol and terephthalic acid. In some embodiments, the polyethylene terephthalate comprises greater than or equal to 90 mole% of repeat units derived from ethylene glycol and terephthalic acid. In still further embodiments, the mole% of the ethylene glycol and terephthalic acid repeat units is greater than or equal to 95 or 96 or 97 or 98 or 99 mole%, wherein the mole percentages are based on the total amount of monomers that form the polyethylene terephthalate.

“Polytrimethylene furandicarboxylate” or “PTF” means a polymer comprising repeat units derived from 1,3-propane diol and furan dicarboxylic acid. In some embodiments, the polytrimethylene furandicarboxylate comprises greater than or equal to 90 mole% of repeat units derived from 1,3-propane diol and furandicarboxylic acid. In still further embodiments, the mole% of the 1,3-propane diol and furandicarboxylic acid repeat units is greater than or equal to 95 or 96 or 97 or 98 or 99 mole%, wherein the mole percentages are based on the total amount of monomers that form the polytrimethylene furandicarboxylate. In some embodiments, the furandicarboxylic acid repeat units are derived from 2,3-furandicarboxylic acid, 2,4-furandicarboxylic acid, 2,5-furandicarboxylic acid or a combination thereof. In other embodiments, the furandicarboxylic acid repeat unit is derived from 2,5-furandicarboxylic acid or an ester derivative thereof such as the dimethyl ester of 2,5-furandicarboxylic acid.

The phrase “repeat units derived from” refer to the monomeric units that form a part of the polymer chain. For example, a repeat unit derived from terephthalic acid means terephthalic acid dicarboxylate regardless of the actual monomer used to make the polymer. The actual monomer that can be used to make the polymer are any of those that are known, for example, terephthalic acid, dimethyl terephthalate, bis(2-hydroxyethyl) terephthalate or others.

Unless the context otherwise indicates (such as in connection with a preform for a film or sheet), the term “preform” means an article having a fully formed bottle neck and a fully formed threaded portion, and a relatively thick tube of polymer that is closed at the end of the thick tube. The neck and threaded portion are sometimes called the “finish”. The thick tube of polymer can be uniform in shape and cross section when viewing the tube from top (neck area) to bottom (closed portion) or can have a variable cross section top to bottom.

The phrase “areal stretch ratio” means the product of the axial stretch ratio times the hoop stretch ratio of a bottle blown from the preform. The phrase “axial stretch ratio” means the (bottle working height)/(preform working length). The phrase “hoop stretch ratio” means the (maximum bottle external diameter)/(preform internal diameter). The bottle working height is defined as the overall bottle height minus the finish height. The preform working length is defined as the overall preform length minus the finish length. The preform inner diameter means the diameter of the cavity of the preform.

The term “stretch ratio” (similar in concept to “areal stretch ratio”) is used to describe the amount of stretching to form an article such as a sheet and/or film, and means the product of a first dimension stretch ratio multiplied by a second dimension stretch ratio for an article. The first dimension (such as length) stretch ratio is the final stretched first dimension divided by the unstretched (i.e., starting) first dimension of the article, and the second dimension (such as width) stretch ratio is the final stretched second dimension divided by the unstretched (i.e., starting) second dimension of the article. For example, in the case of an extruded film which is subsequently bi-axially oriented, the stretch ratio would be the product of the length stretch ratio multiplied by the width stretch ratio, where the length stretch ratio is the final stretched length of the film divided by the starting length of the film obtained from the extruder, and the width stretch ratio is the final stretched width of the film divided by the starting width of the film as obtained from the extruder.

The phrase “identically shaped bottle” means that a mold having the same dimensions is used to make two different bottles. The two bottles will have the same exterior dimensions, for example, bottle height, width and circumference. The weights of the identically shaped bottles may be different.

The phrase “degree of transesterification” means the amount of transesterification between two polyesters in a polyester blend. The degree of transesterification can be measured by Interaction Polymer Chromatography (IPC).

The phrases such as “transesterified PET/PTF composition” or “PET/PTF”, “PET/PTF layer(s)” or “made from PET/PTF” or similar language refers to a mixture comprising, or consisting essentially of, or consisting of polytrimethylene furandicarboxylate (PTF) and polyethylene terephthalate (PET) which has been processed under suitable conditions (such as heat and mixing) to produce a composition where the degree of transesterification between the PTF and PET is at least 1%. In some embodiments the PTF is dispersed in a continuous phase of PET as described in more detail herein.

The term “haze” as used herein refers to the scattering of light as it passes through a transparent article, resulting in poor visibility, reduced transparency, and/or glare. Haze is measured according to the description in the Examples. A greater percent value of haze indicates less clarity and reduced transparency.

Many plastic containers, for example, bottles consisting of PET polymer, are made by first producing a preform followed by stretch blow molding the preform into the bottle. The preform can have a variety of dimensions, depending upon the final size of the bottle. The preform can vary with respect to, for example, body length, body thickness, inside diameter, outside diameter, neck height and base height. As is known in the art, the stretch ratio of a bottle is generally measured by the axial stretch ratio which is the (bottle working height)/(preform working length) and the hoop stretch ratio, which is (maximum bottle internal diameter)/(preform internal diameter). The product of these two ratios, that is, the product of the axial stretch ratio times the hoop stretch ratio is called the areal stretch ratio.

Plastic bottles that are used for containing and/or are in contact with food (e.g., beverage bottles), personal care products, pharmaceutical products, household products and/or industrial products, have certain permeation rate requirements for various gases or vapors to, for example, maintain a desired shelf life for the product, maintain product quality/specifications, or prevent unwanted contamination or undesired degradation of the product. For example, the permeation rates of oxygen, carbon dioxide and/or water vapor must be below certain levels in order to prevent spoilage, reduction in active ingredients, loss of carbonation and/or loss of liquid volume. The acceptable gas permeation rates will vary depending upon the type of product (such as beverage) in the bottle and the requirements in the industry.

Permeation properties are especially an important factor in bottles consisting of PET. Because PET bottles are relatively permeable to both oxygen and carbon dioxide, they must have relatively thick walls in order to provide the desired permeation rates which adds weight to the bottles. It has been found that the weight of a bottle consisting of polyethylene terephthalate polymer, especially a drink bottle, can be reduced by about 5 to 50% by weight, and in other embodiments reduced by about 5 to 35% by weight, by the use of at least 1% by weight to less than or equal to 40% by weight of polytrimethylene furandicarboxylate. For example, if a bottle consisting of polyethylene terephthalate polymer has a weight of 20 grams and has an acceptable rate of permeation to water vapor, oxygen and/or carbon dioxide, then by controlling the transesterification of a melt of a mixture of 89% by weight polyethylene terephthalate and 11% by weight of polytrimethylene furandicarboxylate and the areal stretch ratio, a bottle can be made weighing, for example, 15 grams and the bottle can still retain rates of permeation to oxygen, carbon dioxide and/or water vapor that are equal to or less than the identically shaped bottle consisting of PET.

The amount of polytrimethylene furandicarboxylate in the PET/PTF bottle can have an effect on the percentage of weight that can be reduced when compared to a bottle consisting of PET and still retain the desired barrier properties. For example, if a relatively low amount of PTF is used, for example, 2% by weight, then the weight of the bottle can be reduced by only a relatively small amount. However, if a relatively larger amount of polytrimethylene furandicarboxylate is used, for example, 15% by weight, then the weight of the bottle can be reduced by a relatively larger amount.

In some embodiments, the disclosure relates to a process for reducing the weight of a polyethylene terephthalate bottle comprising:
a) replacing in the range of from 1% to 40% by weight of the polyethylene terephthalate with polytrimethylene furandicarboxylate;
   wherein the PET/PTF bottle has an oxygen permeation rate, a carbon dioxide permeation rate and/or a water vapor permeation rate that is less than or equal to an identically shaped bottle consisting of polyethylene terephthalate polymer and weighing 1.05 to 2.00 times or in some embodiments 1.05 to 1.54 times the weight of the PET/PTF bottle; wherein the degree of transesterification of the polyethylene terephthalate and the polytrimethylene furandicarboxylate is in the range of from 0.1 to 99.9%; and
   wherein the bottle has an areal stretch ratio in the range of from 5 to 30 or in other embodiments from 5 to 25.

The process of “reducing the weight of a polyethylene terephthalate bottle” means forming a PET/PTF bottle wherein the PET/PTF bottle weighs 5 to 50% less, or in some embodiments, weighs 5 to 35% less than an identically shaped bottle consisting of PET and the PET/PTF bottle still retains gas permeation rates that are equal to or less than the PET bottle. Replacing the PET with PTF means forming a bottle from a relatively lightweight preform, wherein the preform is produced from a blend of both polyethylene terephthalate and polytrimethylene furandicarboxylate. The preform can be produced by first mixing the desired weight percentages of both polyethylene terephthalate and polytrimethylene furandicarboxylate polymers. In some embodiments, the weight percentages can be in the range of from 60% to 99% by weight of PET and from 1% to 40% by weight of PTF. The percentages by weight are based on the total amount of the PET and PTF. In other embodiments, the amounts of polytrimethylene furandicarboxylate can be in the range of from 3 to 35% or from 5 to 30% or from 5 to 25% or from 5 to 20% or from 5 to 15% by weight and the amounts of polyethylene terephthalate can be in the range of from 65 to 97% or from 70 to 95% or from 75 to 95% or from 80 to 95% or from 85 to 95% by weight, respectively, wherein the percentages by weight are based on the total amount of the polyethylene terephthalate and the polytrimethylene furandicarboxylate. In still further embodiments, the amount polytrimethylene furandicarboxylate can be 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40% and the amount of polyethylene terephthalate can be 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or 99% by weight, wherein the percentages by weight are based on the total amount of the polyethylene terephthalate and the polytrimethylene furandicarboxylate.

The mixture can then be thoroughly mixed, for example, melted as a mixture in an extruder, a single screw extruder or a twin screw extruder. The extruder allows contact between the two polymers in the melt which results in a degree of transesterification in the range of from 0.1 to 99.9%. This replacement or substitution of 1 to 40% by weight of the PET with PTF can allow a relatively lower weight preform to be produced that, when blown into a bottle, has an oxygen, carbon dioxide and/or water vapor permeation rate that is less than or equal to the higher weight bottle consisting of PET.

It is well known that the measurement of permeation rates for various gases through polymers has a measure of inherent variability. Therefore, due to the known variability in measuring the various permeation rates for oxygen, carbon dioxide and/or water vapor, the relatively lightweight PET/PTF bottle will be considered to have a permeation rate that is “equal to or less than” an identically shaped bottle consisting of PET and weighing 1.05 to 2.00 times, or in other embodiments weighing 1.05 to 1.54 times the weight of the PET/PTF bottle, if the permeation rates, when measured using the ASTM methods given in the examples, of the PET/PTF bottle is at most 10% greater. For example, if the average of three oxygen permeation rate measurements for a 100% PET bottle weighing 25 grams is 0.2 cc/package.day.atm in a 100% O₂ atmosphere, then the permeation rate for an identically shaped PET/PTF bottle containing 20% PTF weighing 20 grams is considered to be equal to or less than the 100% PET bottle if the average of three oxygen permeation rate measurements for the PET/PTF bottle is at most 0.22 cc/package.day.atm in a 100% O₂ atmosphere. In other embodiments, when the permeation rate of the PET/PTF bottle is at most 9% greater than the rates of the 100% PET bottle, the permeation rate will be considered to be equal to or less than the 100% PET bottle. In still further embodiments, when the permeation rate of the PET/PTF bottle is at most 8% or 7% or 6% or 5% greater than the permeation rate of the 100% PET bottle, the permeation rate will be considered to be equal to or less than the 100% PET bottle. In other embodiments, the PET/PTF bottle can weigh 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50% less than an identically shaped bottle consisting of PET and have a rate of permeation to oxygen, carbon dioxide and/or water vapor that is equal to or less than the PET bottle.

It can be important to control the amount of transesterification in the mixture of the polyethylene terephthalate and the polytrimethylene furandicarboxylate. In some embodiments, the degree of transesterification can be in the range of from 0.1 to 99.9%. In other embodiments, the degree of transesterification between the PET and the PTF can be in the range of from at least 1%, or from 10 to 100%, or from 50 to 100%, or from 60 to 100%, or from 70 to 100% or from 80 to 100%. In other embodiments the degree of transesterification can be in the range of from 10 to 90% or from 20 to 80% or from 30 to 80% or from 40 to 80% or from 50 to 70% or from 40 to 65%. In other embodiments, the degree of transesterification can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% or 100%.

Controlling the degree of transesterification can improve or alter certain properties of the articles described herein containing PET/PTF. For example, it has been found that barrier properties and/or the amount of haze can be controlled and/or improved through adjusting the degree of transesterification.

For example, with respect to the barrier properties of a bottle, it is believed that the degree of transesterification necessary to improve the barrier properties is variable, depending at least on the amounts of polyethylene terephthalate and the polytrimethylene furandicarboxylate in the article. For example, the maximum improvement in the barrier properties for a bottle comprising 90% by weight of polyethylene terephthalate and 10% amorphous polytrimethylene furandicarboxylate occurs when the degree of transesterification is in the range of from 50 to 70%. In another example, the maximum improvement in the barrier properties for bottle comprising 80% by weight of polyethylene terephthalate and 20% amorphous polytrimethylene furandicarboxylate occurs when the degree of transesterification is in the range of from 40 to 65%.

With respect to the amount of haze of a bottle made from PET/PTF, it is believed that the amount of haze is related to the amount by weight of the PTF that is replacing the PET, and degree of transesterification, where lower amounts by weight of PTF replacing the PET, and/or higher degrees of transesterification can result in lower amounts of haze. It has been found that for bottles comprising from 80 to 95% by weight PET and from 5 to 20% by weight PTF based on the total weight of the bottle, that the amount of haze, as measured as described in the Examples, is decreased when the degree of transesterification is increased. Where it is desired to have little or no amount of haze, the degree of transesterification may be in the range of from 50 to 100%, or from 60 to 100%, or from 70 to 100%, or from 80 to 100%.

In embodiments where little or no amount of haze is desired for a PET/PTF containing article (such as a bottle for beverages or flexible plastic wrap for food), the haze may range for example from 0 to 10%, or from 0 to 5%, or from 0 to 3% or from 0.5 to 2%.

The degree of transesterification can be a function of both the processing temperature and the length of time the mixture spends at or above the melt temperature. Therefore, controlling the time and temperature is an important factor in obtaining the desired degree of transesterification. The melting temperature of crystalline PET is generally about 230 to 265° C. and the melting point of PTF is about 175 to 180° C. Therefore, the processing temperature to produce the preform can be in the range of from 230° C. to 325° C. In other embodiments, the temperature can be in the range of from 240° C. to 320° C. or from 250° C. to 310° C. or from 260° C. to 300° C. In general, the processing times, that is, the length of time at which the mixture of the PET and PTF spends in the extruder, can be in the range of from 30 seconds to 10 minutes. In other embodiments, the time can be in the range of from 1 minute to 9 minutes or from 1 minute to 8 minutes. In general, with transit times through the extruder being equal, higher temperatures favor higher degrees of transesterification, while shorter times favor lower degrees of transesterification. Additionally, with the extruder temperatures being constant, longer processing times favor a higher degree of transesterification, while shorter processing times favor lower amounts of transesterification. It should also be noted that herein the “temperature” refers to the barrel temperature which is controlled by the operator. The true temperature experienced by the melt typically varies from this value and will be influenced from machine to machine, extruder design, wear, instrinsic viscosity (IV) of the polymer grade, screw configuration, and other injection parameters.

The areal stretch ratio can also have an influence on the barrier properties of the bottle. The areal stretch ratio of the bottle can be any number in the range of from 5 to 30, or 5 to 29, or 5 to 28, or 5 to 27, or 5 to 26. In other embodiments, the areal stretch ratio can be any number in the range of from 5 to 25, or 6 to 25, or 7 to 25, or 8 to 25, or 9 to 25, or 10 to 25, or 11 to 25, or 12 to 25, or 13 to 25, or 14 to 25, or 15 to 25, or 16 to 25, or 17 to 25. In other embodiments, the areal stretch ratio can be any number from 12 to 30, 12 to 29, or 12 to 28 or 12 to 27 or 12 to 26 or 12 to 25, or 12 to 24, or 12 to 23, or 12 to 21, or 12 to 20, or 12 to 19, or 12 to 18. In other embodiments, the areal stretch ratio can be any number in the range of from 6 to 24, or 7 to 23, or 8 to 22, or 9 to 21, or 10 to 20. In still further embodiments, the areal stretch ratio can be in the range of from 12 to 20, or from 13 to 19, or from 14 to 18.

In other embodiments, the disclosure relates to a process for reducing the weight of a polyethylene terephthalate bottle comprising:
a) blowing a preform to form a bottle;
   wherein the preform comprises in the range of from 60% to 99% by weight of polyethylene terephthalate and in the range of from 1% to 40% by weight of polytrimethylene furandicarboxylate having a degree of transesterification between the polyethylene terephthalate and the polytrimethylene furandicarboxylate in the range of from 0.1 to 99.9%; wherein the oxygen permeation rate, the carbon dioxide permeation rate and/or the water vapor permeation rate is less than or equal to a bottle consisting of PET polymer and having a weight that is 1.05 to 2.00 times or in some embodiments 1.05 to 1.54 times the weight of the PET/PTF bottle; and
   wherein the areal stretch ratio of the bottle is in the range of from 5 to 30 or in some embodiments 5 to 25.

The process of “reducing the weight of the polyethylene terephthalate bottle” by blowing a preform to form the bottle refers to the weight of a preform comprising polyethylene terephthalate and polytrimethylene furandicarboxylate relative to the weight of a preform consisting of polyethylene terephthalate. In order to reduce the weight of the bottle, a preform is produced wherein the preform comprises in the range of from 60% to 99% by weight of polyethylene terephthalate and 1% to 40% by weight of polytrimethylene furandicarboxylate and the PET/PTF preform weighs 5 to 50% less and in other embodiments from 5 to 35% less than the PET preform, yet the bottle produced from the preform has a gas permeation rate that is less than or equal to an identically shaped bottle consisting of PET.

In other embodiments, the disclosure relates to a process comprising:
a) heating a mixture comprising in the range of from 1% to 40% by weight of polytrimethylene furandicarboxylate and in the range of from 60% to 99% by weight of polyethylene terephthalate to form a polymer melt, wherein the percentages by weight are based on the total weight of the polymer melt; and
b) forming a preform from the polymer melt, wherein:
   the degree of transesterification between the polytrimethylene furandicarboxylate and the polyethylene terephthalate is in the range of from 0.1% to 99.9%.

The process can further comprise the step of:

c) blowing the preform to form a bottle, wherein the areal stretch ratio of the bottle is in the range of from 5 to 30 or in some embodiments from 5 to 25.

Any of the above disclosed processes can result in a bottle having acceptable visual properties as well as the desired gas barrier layers.

The process comprises a first step:

i) heating a mixture comprising in the range of from 1% to 40% by weight of polytrimethylene furandicarboxylate and in the range of from 60% to 99% by weight of polyethylene terephthalate to form a polymer melt, wherein the percentages by weight are based on the total weight of the polymer melt.

The heating of the mixture can be accomplished using any of the known heating techniques. In general, the heating step can take place in an apparatus that can also be used to produce the preform, for example, using an extruder and/or injection molding machine. In some embodiments, the mixture comprises or consists essentially of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40% by weight of polytrimethylene furandicarboxylate, based on the total weight of polyethylene terephthalate and polytrimethylene furandicarboxylate. The PET and PTF can be blended as particles in the desired weight ratio to form the mixture prior to heating the mixture. In other embodiments, the desired weight percentages of PET and PTF can be fed separately to the same or different heating zones of the extruder. The particles can be in the form of, for example, powders, flakes, pellets or a combination thereof.

The mixture of particles can be fed to the extruder where the mixture enters one or more heating zones and is conveyed along at least a portion of the length of the extruder to form the polymer melt. In the extruder, the polymer melt may be subject to one or more heating zones each independently operating at the same or different temperatures. The heating zones typically operate at a temperature in the range of from 230° C. to 325° C. and the extruder provides at least some mixing to the polymer melt. In other embodiments, the temperature can be in the range of from 240° C. to 320° C. or from 250° C. to 310° C. or from 260° C. to 300° C. The intimate contact of the polyethylene terephthalate and the polytrimethylene furandicarboxylate in the polymer melt can result in a degree of transesterification between the two polymers, thereby forming a blend comprising or consisting essentially of PET, PTF and a copolymer comprising repeat units from both polymers. The degree of transesterification can be in the range of from 0.1% to 99.9%. In some embodiments, the degree of transesterification between the PET and the PTF can be in the range of from 10 to 100%, or from 50 to 100%, or from 60 to 100%, or from 70 to 100%. In other embodiments, the degree of transesterification between the PET and the PTF can be in the range of from 10 to 90% or from 20 to 80% or from 30 to 80% or from 40 to 80% or from 50 to 70% or from 40 to 65%. In other embodiments, the degree of transesterification can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or 99%. Dependent upon the degree of transesterification, the final product can form a substantially continuous phase product of PET/PTF. By “substantially continuous phase” it is meant that the degree of transesterification is from 80 to 100% or from 90 to 100% or from 95 to 100%. In other embodiments, the preform or the bottle comprises a continuous phase of polyethylene terephthalate and a discontinuous phase of polytrimethylene furandicarboxylate. The products wherein the PTF forms a discrete phase within the continuous PET phase can be referred to as a salt-and-pepper blend or a masterbatch.

The process also comprises the step of ii) forming a preform from the polymer melt. The polymer melt from step i) can be injection molded into a mold having the shape of the preform. Typically, the mold is defined by a female mold cavity mounted to a cavity plate and a male mold core mounted to a core plate. The two pieces of the mold are held together by force, for example, by a clamp and the molten polymer mixture is injected into the mold. The preform is cooled or allowed to cool. The mold pieces can be separated and the preform removed from the mold. The preform can have a variety of shapes and sizes depending upon the desired shape and size of the bottle to be produced from the preform.

The process can further comprise the step of iii) blowing the preform to form a bottle. In some embodiments, the bottle can be blown from the preform shortly after the preform has been produced, that is, while the preform still retains enough heat to be shaped into the bottle, for example, shortly after formation up to about one hour. In other embodiments, the preform can be cooled and the desired bottle can be formed at a later time, for example, more than one hour to one year or more after formation of the preform. Typically, the preform is blow molded to form the bottle at a temperature in the range of from 80 to 120° C. using any of the known blow molding techniques. The molding of the preform into a bottle biaxially stretches the preform. The amount of stretching from the initial dimensions of the preform to the dimensions of the bottle can be used to determine the areal stretch ratio. It has also been found that the areal stretch ratio of the bottle can affect the gas permeation rate. The “areal stretch ratio” means the product of the axial stretch ratio times the hoop stretch ratio. The phrase “axial stretch ratio” means the (bottle working height)/(preform working length). The phrase “hoop stretch ratio” means the (maximum bottle external diameter)/(preform internal diameter). In some embodiments, the areal stretch ratio can be in the range of from 12 to 30, or from 12 to 20, or from 13 to 20, or from 14 to 19, or from 15 to 19, or from 15.5 to 19. In other embodiments, the areal stretch ratio can be any number in the range of from 6 to 25, or 7 to 25, or 8 to 25, or 9 to 25, or 10 to 25, or 11 to 25, or 12 to 25, or 13 to 25, or 14 to 25, or 15 to 25, or 16 to 25, or 17 to 25. In other embodiments, the areal stretch ratio can be any number from 12 to 25, or 12 to 24, or 12 to 23, or 12 to 21, or 12 to 20, or 12 to 19, or 12 to 18. In other embodiments, the areal stretch ratio can be any number in the range of from 6 to 24, or 7 to 23, or 8 to 22, or 9 to 21, or 10 to 20. In still further embodiments, the areal stretch ratio can be in the range of from 12 to 20, or from 13 to 19, or from 14 to 18.

Single stage, two stage and double blow molding techniques can be used to produce the bottle from the preform. In the single stage process, preforms are produced, cooled to the blow molding temperature and blown to form the bottles. In this process, the heat remaining from the preform production process is sufficient to allow the preform to be stretch blow molded. In a two stage process, the preforms are produced and then stored for a period of time and blown into bottles after being reheated to a temperature around the glass transition temperature.

The polyethylene terephthalate and the polytrimethylene furandicarboxylate can be from any source. PET is commonly used for the manufacture of packaging articles such as thermoformed articles, flexible or rigid films or sheets, and containers such as preforms and bottles. Any grades of PET that are currently used and suitable for manufacture of these articles can be utilized. For example, PET containing various levels of diacid comonomers, such as isophthalic acid, and/or diol comonomers such as cyclohexane dimethanol, and/or tetramethyl cyclobutane diol, may be used, or alternatively pure PET may be used. The polytrimethylene furandicarboxylate can have a weight average molecular weight in the range of from 150 to 300,000 Daltons. In other embodiments, the weight average molecular weight of the polytrimethylene furandicarboxylate can be in the range of from 200 to 200,000 Daltons or in other embodiments from 40,000 to 90,000 Daltons.

Typically, the polyethylene terephthalate and the polytrimethylene furandicarboxylate will comprise one or more catalysts that were present during the polymerization to form the polyesters. These catalysts may still be present and can help to facilitate the desired degree of transesterification. The polyethylene terephthalate may comprise a germanium catalyst, an antimony catalyst or a combination thereof. The polytrimethylene furandicarboxylate may comprise a titanium catalyst. In other embodiments, the polytrimethylene furandicarboxylate may comprise a titanium alkoxide, for example, titanium ethoxide, titanium propoxide, titanium butoxide. In other embodiments, the polytrimethylene furandicarboxylate may comprise one or more of tin oxide, tin alkoxide, bismuth oxide, bismuth alkoxides, zinc alkoxide, zinc oxide, antimony oxide, germanium oxide, germanium alkoxide, aluminum oxide, aluminum alkoxide or a combination thereof.

In some embodiments, the PET/PTF blend can be a copolymer that is produced by the polymerization of a monomer mixture, wherein the monomer mixture comprises or consists of terephthalic acid or a derivative thereof, furan dicarboxylic acid or a derivative thereof, ethylene glycol and 1,3-propane diol. The terephthalic and furan dicarboxylic acids can be the dicarboxylic acid or derivatives thereof. Suitable derivatives thereof can be the alkyl esters containing from 1 to 6 carbon atoms, or the acid halides, for example, the methyl, ethyl or propyl esters or the diacid chlorides. In still further embodiments, the terephthalic and furan dicarboxylic acid derivatives are the dimethyl esters, for example dimethyl terephthalate and furan dicarboxylic acid dimethyl ester. The PET/PTF blends made in this manner can have a very high degree of transesterification, for example, greater than 90%. In other embodiments, the degree of transesterification may be greater than 95 or 96 or 97 or 98 or 99%.

In some embodiments, the monomer mixture can further comprise additional comonomers, for example, 1,4-benzenedimethanol, poly(ethylene glycol), poly(tetrahydrofuran), 2,5-di(hydroxymethyl)tetrahydrofuran, isosorbide, isomannide, glycerol, pentaerythritol, sorbitol, mannitol, erythritol, threitol, isophthalic acid, adipic acid, azelic acid, sebacic acid, dodecanoic acid, 1,4-cyclohexane dicarboxylic acid, maleic acid, succinic acid, 1,3,5-benzenetricarboxylic acid, glycolic acid, hydroxybutyric acid, hydroxycaproic acid, hydroxyvaleric acid, 7-hydroxyheptanoic acid, 8-hydroxycaproic acid, 9-hydroxynonanoic acid, or lactic acid; or those derived from pivalolactone, ε-caprolactone, L,L-, D,D- D,L-lactides or a combination thereof. The additional comonomers typically comprises less than 30 mole%, 20 mole%, 10 mole%, 9 mole%, 8 mole%, 7 mole%, 6 mole%, 5 mole%, 4 mole%, 3 mole%, 2 mole% or 1 mole%, wherein the mole percentages are based on the total monomer mixture.

The bottle can be a single layer bottle or it can be a multilayered bottle. For example, the bottle can consist of one layer, two layers, three layers, four layers or five or more layers. In any of the embodiments comprising two or more layers, at least one of the layers is the transesterified PET/PTF layer. The PET/PTF layer can be the outermost layer, for example, the layer in contact with the atmosphere, the PET/PTF layer can be the innermost layer, for example, the layer in contact with the contents of the bottle, or the PET/PTF layer can be an inner layer surrounding on both sides by one or more other layers. In embodiments comprising more than one layer, the second and/or subsequent layer can be one or more of a PET layer, a PTF layer, a second PET/PTF layer produced according to the methods above, a polyolefin layer, a polyethylene layer, a poly(vinyl alcohol) layer, an ethylene vinyl alcohol layer, a poly(acrylonitrile)layer, a poly(ethylene naphthalene) layer, a polyamide layer, a layer derived from adipic acid and m-xylenediamine (MXD6), a poly(vinylidene chloride) layer or a combination thereof.

The bottles as described herein may be used to contain food, personal care products, pharmaceutical products, household products, and/or industrial products. Examples of food which may be contained in the bottles include for example beverages such as carbonated soft drinks, sparkling water, beers, fruit juices, vitamin water, wine, and solid foods sensitive to oxygen such as packaged fruits and vegetables. Examples of personal care products which may be contained in bottles described herein include skin care compositions, hair care compositions, cosmetic compositions, and oral care compositions. Examples of pharmaceutical products which may be contained in the bottles described herein include for example antibacterial compositions, antifungal compositions or other compositions containing an active ingredient in a pharmacologically effective amount. Examples of household and/or industrial compositions which may be contained in the bottles described herein include for example fabric care products such as liquid fabric softeners and laundry detergents, hard surface cleaners, dishwashing detergents, liquid hand soaps, paints such as water-based paints; adhesives; sealants and caulks; and garden products (e.g., fertilizers, fungicides, weed control products, etc.).

The processes as described herein for reducing the weight of polyethylene terephthalate bottles may also be used for reducing the weight of other polyethylene terephthalate articles used for packaging such as containers that are not in the shape of a bottle such as thermoformed articles and films or sheets, such as for example: i) a single flexible film layer consisting of, or comprising the transesterified PET/PTF composition or a multilayered flexible film where at least one layer of the multilayered flexible film consists of, or comprises the transesterified PET/PTF composition or ii) a single rigid sheet layer consisting of, or comprising the transesterified PET/PTF composition or a multilayered rigid sheet where at least one layer of the multilayered sheet consists of, or comprises the transesterified PET/PTF composition. In such embodiments, a process is provided for reducing the weight of a polyethylene terephthalate (PET) article comprising:
a) replacing in the range of from 5% to 40% or from 5% to 30% by weight of the polyethylene terephthalate with polytrimethylene furandicarboxylate (PTF) to form a PET/PTF article;
   wherein the PET/PTF article has an oxygen permeation rate, a carbon dioxide permeation rate and/or a water vapor permeation rate that is less than or equal to an identically shaped article consisting of polyethylene terephthalate polymer and weighing 1.05 to 2.00 times, or in some embodiments 1.05 to 1.54 times the weight of the PET/PTF article; where the degree of transesterification of the polyethylene terephthalate and the polytrimethylene furandicarboxylate is in the range of from 50 to 100% and the article is selected from a thermoformed article, a flexible film, or a rigid sheet having one or more layers comprising the PET/PTF that has been transesterified, and wherein the stretch ratio of the PET/PTF article ranges from 5 to 30, or in some embodiments from 5 to 25.

The process of “reducing the weight of a polyethylene terephthalate article” means forming a PET/PTF article wherein the PET/PTF article weighs 5 to 50% less or in other embodiments 5 to 35% less than an identically shaped article consisting of PET and the PET/PTF article still retains one or more gas permeation rates and/or water vapor permeation rates that are equal to or less than the PET article.

In some embodiments, the amounts of polytrimethylene furandicarboxylate can be in the range of from 5 to 30%, or from 5 to 25% or from 5 to 20% or from 5 to 15% by weight and the amounts of polyethylene terephthalate can be in the range of from 70 to 95% or from 75 to 95% or from 80 to 95% or from 85 to 95% by weight, respectively, wherein the percentages by weight are based on the total amount of the polyethylene terephthalate and the polytrimethylene furandicarboxylate. In still further embodiments, the amount polytrimethylene furandicarboxylate can be 5, 6, 7, 8, 9, 10, 11, 12, 13, 14, 15, 16, 17, 18, 19, 20, 21, 22, 23, 24, 25, 26, 27, 28, 29, or 30% and the amount of polyethylene terephthalate can be 70, 71, 72, 73, 74, 75, 76, 77, 78, 79, 80, 81, 82, 83, 84, 85, 86, 87, 88, 89, 90, 91, 92, 93, 94, 95% by weight, wherein the percentages by weight are based on the total amount of the polyethylene terephthalate and the polytrimethylene furandicarboxylate.

In some embodiments, the degree of transesterification between the PET and the PTF can be in the range of from 50 to 100% or from 60 to 100%, or from 70 to 100% or from 80 to 100%. In other embodiments, the degree of transesterification between the PET and the PTF can be in the range of from 50 to 70% or from 50 to 65%.

Sheets and films will typically differ in thickness, but, as the thickness of an article will vary according to the needs of its application, it is difficult to set a standard thickness that differentiates a film from a sheet. A sheet as used herein will typically have a thickness greater than about 0.25 mm (10 mils). The thickness of the sheets herein may be from about 0.25 mm to about 25 mm, or in other embodiments from about 2 mm to about 15 mm, and in yet other embodiments from about 3 mm to about 10 mm. In some embodiments, the sheets hereof have a thickness sufficient to cause the sheet to be rigid, which generally occurs at about 0.50 mm and greater. However, sheets thicker than 25 mm, and thinner than 0.25 mm may be formed. Films formed herein will typically have a thickness that is less than about 0.25 mm. A film or sheet herein can be oriented or not oriented, or uniaxially oriented or biaxially oriented.

A film or sheet may be formed for example by extrusion. For example, see WO 96/38282 and WO 97/00284, which describe the formation of crystallizable thermoplastic sheets by melt extrusion.

In one embodiment, sheets or films can be formed by feeding particles of PET and PTF separately or as a mixture in the desired amounts to an extruder where the particles are mixed and enter one or more heating zones and are conveyed along at least a portion of the length of the extruder to form a polymer melt. In the extruder, the polymer melt may be subject to one or more heating zones each independently operating at the same or different temperatures. The heating zones typically operate at a temperature in the range of from 230° C. to 325° C. and the extruder provides at least some mixing to the polymer melt. In other embodiments, the temperature can be in the range of from 240° C. to 320° C. or from 250° C. to 310° C. or from 260° C. to 300° C. The intimate contact of the polyethylene terephthalate and the polytrimethylene furandicarboxylate in the polymer melt can result in a degree of transesterification between the two polymers as previously described herein, thereby forming a blend comprising or consisting essentially of PET, PTF and a copolymer comprising repeat units from both polymers.

The polymer melt formed in the extruder is then forced through a suitably shaped die to produce the desired cross-sectional shape. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw and multi-screw extruders may be used as known in the art.

Upon exiting the extruder or after a predetermined time, the resulting film or sheet preformed can be further processed to form a desired shaped article such as an oriented film or sheet which may be for example a uniaxially oriented or biaxially oriented or be thermoformed into an article.

The sheets or films can be a single layer, or can be multilayered. For example, the sheet or film can consist of one layer, two layers, three layers, four layers or five or more layers. In any of the embodiments comprising two or more layers, at least one of the layers is the transesterified PET/PTF layer. The PET/PTF layer can be the outermost layer, for example, the layer in contact with the atmosphere, the PET/PTF layer can be the innermost layer, for example, the layer in contact with the product to be package, or the PET/PTF layer can be an inner layer surrounding on both sides by one or more other layers. In embodiments comprising more than one layer, the second and/or subsequent layer can be one or more of a PET layer, a PTF layer, a second PET/PTF layer produced according to the methods above, a polyolefin layer, a polyethylene layer, a poly(vinyl alcohol) layer, an ethylene vinyl alcohol layer, a poly(acrylonitrile)layer, a poly(ethylene naphthalene) layer, a polyamide layer, a layer derived from adipic acid and m-xylylenediamine (MXD6), a poly(vinylidene chloride) layer or a combination thereof.

Thermoformed PET/PTF articles may be produced for example by providing a sheet (single or multilayered) described above containing at least one PET/PTF transesterified layer and heating the sheet to a pliable forming temperature, and forming the sheet into a specific shape in a mold.

In some embodiments the PET/PTF article formed (such as a film or sheet) has a stretch ratio (relative to its preform) ranging from 5 to 30, or 5 to 29, or 5 to 28, or 5 to 27, or 5 to 26. In other embodiments, the stretch ratio can be any number in the range of from 5 to 25, or 6 to 25, or 7 to 25, or 8 to 25, or 9 to 25, or 10 to 25, or 11 to 25, or 12 to 25, or 13 to 25, or 14 to 25, or 15 to 25, or 16 to 25, or 17 to 25. In other embodiments, the stretch ratio can be any number from 12 to 30, 12 to 29, or 12 to 28 or 12 to 27 or 12 to 26 or 12 to 25, or 12 to 24, or 12 to 23, or 12 to 21, or 12 to 20, or 12 to 19, or 12 to 18. In other embodiments, the stretch ratio can be any number in the range of from 6 to 24, or 7 to 23, or 8 to 22, or 9 to 21, or 10 to 20. In still further embodiments, the stretch ratio can be in the range of from 12 to 20, or from 13 to 19, or from 14 to 18.

Non-limiting examples of the processes disclosed herein include:

Embodiment 1. A process for reducing the weight of a polyethylene terephthalate (PET) bottle comprising:
a) replacing in the range of from 1% to 40% by weight of the polyethylene terephthalate with polytrimethylene furandicarboxylate (PTF) to provide a PET/PTF bottle;
   wherein the PET/PTF bottle has an oxygen permeation rate, a carbon dioxide permeation rate and/or a water vapor permeation rate that is less than or equal to an identically shaped bottle consisting of polyethylene terephthalate polymer and weighing 1.05 to 2.00 times or in some embodiments 1.05 to 1.54 times the weight of the PET/PTF bottle; wherein the degree of transesterification of the polyethylene terephthalate and the polytrimethylene furandicarboxylate is in the range of from 0.1 to 99.9%; and
   wherein the bottle has an areal stretch ratio in the range of from 5 to 30 or in other embodiments from 5 to 25.

Embodiment 2. A process for reducing the weight of a polyethylene terephthalate (PET) bottle comprising:

a) blowing a preform to form a PET/PTF bottle;
wherein the preform comprises in the range of 60% to 99% by weight of polyethylene terephthalate and 1% to 40% by weight of polytrimethylene furandicarboxylate; wherein the PET/PTF bottle has a degree of transesterification between the polyethylene terephthalate and the polytrimethylene furandicarboxylate ranging from 0.1 to 99.9%;
wherein the PET/PTF bottle has an oxygen permeation rate, a carbon dioxide permeation rate and/or a water vapor permeation rate that is less than or equal to an identically shaped bottle consisting of PET polymer that has a weight that is 1.05 to 2.00 times or in some embodiments 1.05 to 1.54 times the weight of the PET/PTF bottle; and wherein the PET/PTF bottle has an areal stretch ratio in the range of from 5 to 30 or in some embodiments of from 5 to 25.

Embodiment 3. The process of embodiment 1 or 2 wherein the amount of polytrimethylene furandicarboxylate is in the range of from 5 to 40% by weight or from 5 to 30% by weight, or from 5 to 15% by weight, based on the total amount of polyethylene terephthalate and polytrimethylene furandicarboxylate.

Embodiment 4. The process of any one of embodiments 1, 2 or 3 wherein the bottle has an areal stretch ratio in the range of from 12 to 30 or from 10 to 20.

Embodiment 5. The process of any one of embodiments 1, 2, 3 or 4 wherein the degree of transesterification is in the range of from 10 to 90% or from 50 to 100%.

Embodiment 6. The process of any one of embodiments 1, 2, 3, 4 or 5 wherein the polytrimethylene furandicarboxylate comprises a titanium alkoxide catalyst and the polyethylene terephthalate comprises an antimony catalyst.

Embodiment 7. The process of any one of embodiments 1, 2, 3, 4, 5 or 6, wherein the bottle comprises a continuous phase of polyethylene terephthalate and a discontinuous phase of polytrimethylene furandicarboxylate, or the bottle comprises a substantially continuous phase of polyethylene terephthalate and polytrimethylene furandicarboxylate.

Embodiment 8. The process of any one of embodiments 1, 2, 3, 4, 5, 6 or 7 wherein the polytrimethylene furandicarboxylate has a weight average molecular weight in the range of from 150 to 300,000 Daltons, or in other embodiments from 40,000 to 90,000 Daltons.

Embodiment 9. The process of any one of embodiments 1, 2, 3, 4, 5, 6, 7 or 8 wherein the bottle is a monolayer bottle or wherein the bottle is a multilayer bottle.

Embodiment 10. A process comprising:
i) heating a mixture comprising 1% to 40% by weight of polytrimethylene furandicarboxylate and 60% to 99% by weight of polyethylene terephthalate to form a polymer melt, wherein the percentages by weight are based on the total weight of the polymer melt; and
ii) forming a preform from the melt, wherein:
   the degree of transesterification between the polyethylene terephthalate and the polytrimethylene furandicarboxylate is in the range of from 0.1 to 99.9%.

Embodiment 11. The process of embodiment 10 further comprising:

iii) blowing the preform to form a bottle.

Embodiment 12. The process of any one of embodiments 10 or 11 wherein the mixture comprises particles of polyethylene terephthalate and particles of polytrimethylene furandicarboxylate.

Embodiment 13. The process of any one of embodiments 10, 11 or 12 wherein the degree of transesterification is in the range of from 10 to 90% or alternatively from 50 to 100%.

Embodiment 14. The process of any one of embodiments 10, 11, 12 or 13 wherein the polytrimethylene furandicarboxylate comprises a titanium alkoxide and the polyethylene terephthalate comprises antimony.

Embodiment 15. The process of any one of embodiments 10, 11, 12, 13 or 15 wherein the preform comprises a continuous phase of polyethylene terephthalate and a discontinuous phase of polytrimethylene furandicarboxylate, or the preform comprises a substantially continuous phase of polyethylene terephthalate and polytrimethylene furandicarboxylate.

Embodiment 16. The process of any one of embodiments 10, 11, 12, 13, 14 or 15 wherein the polytrimethylene furandicarboxylate has a weight average molecular weight in the range of from 150 to 300,000 Daltons or from 40,000 to 90,000 Daltons.

Embodiment 17. The process of any one of embodiments 10, 11, 12, 13, 14, 15 or 16 wherein the bottle has an oxygen permeation rate or a carbon dioxide permeation rate that is less than or equal to an identically shaped bottle produced from a PET preform weighing 1.05 to 2.00 times, or in some embodiments, 1.05 to 1.54 times the weight of the PET/PTF preform.

Embodiment 18. The process of any one of embodiments 10, 11, 12, 13, 14, 15, 16 or 17 wherein the preform is a single layer of a polymer or wherein the preform is a multilayered structure comprising two or more layers.

Embodiment 19. The process of any one of embodiments 10, 11, 12, 13, 14, 15, 16, 17 or 18 wherein the amount of polytrimethylene furandicarboxylate is in the range of from at least 5% by weight to less than or equal to 30% by weight, or from at least 5% by weight to less than or equal to 20% by weight.

Embodiment 20. The process of any one of embodiments 10, 11, 12, 13, 14, 15, 16, 17, 18 or 19 wherein the bottle has an areal stretch ratio in the range of from 12 to 30, or from 10 to 20.

Embodiment 21. A process for reducing the weight of a polyethylene terephthalate (PET) article comprising:
a) replacing in the range of from 5% to 40% by weight or from 5% to 30% by weight of the polyethylene terephthalate with polytrimethylene furandicarboxylate (PTF) to provide a PET/PTF article;
   wherein the PET/PTF article has an oxygen permeation rate, a carbon dioxide permeation rate and/or a water vapor permeation rate that is less than or equal to an identically shaped article consisting of polyethylene terephthalate polymer and weighing 1.05 to 2.00 or 1.05 to 1.54 times the weight of the PET/PTF article; where the degree of transesterification of the polyethylene terephthalate and the polytrimethylene furandicarboxylate is in the range of from 50 to 100% or from 70 to 100% and the article is selected from a thermoformed article, a flexible film, or a rigid sheet having one or more layers containing the PET/PTF that has been transesterified.

Embodiment 22. The process of embodiment 21 wherein one or more of the following conditions are met: i) the amount of polytrimethylene furandicarboxylate is in the range of from 5 to 20% by weight, or from 5 to 15% by weight, based on the total amount of polyethylene terephthalate and polytrimethylene furandicarboxylate; ii) the article has a stretch ratio in the range of from 12 to 30 or from 10 to 20; iii) the polytrimethylene furandicarboxylate has a weight average molecular weight in the range of from 150 to 300,000 Daltons or from 40,000 to 90,000 Daltons; and/or iv) the PET/PTF article comprises a continuous phase of polyethylene terephthalate and a discontinuous phase of polytrimethylene furandicarboxylate, or the article comprises a substantially continuous phase of polyethylene terephthalate and polytrimethylene furandicarboxylate.

Embodiment 23. The process of any of embodiments 1 through 22 further comprising filling the bottle or article with food, a personal care product, a pharmaceutical product, a household product, and/or an industrial product.

Embodiment 24. The process of any of embodiments 1 through 23 wherein the bottle or article has a haze of from 0 to 10% or from 0 to 3% or from 0.5 to 2%.

### EXAMPLES

Unless otherwise stated, all materials are available from Sigma-Aldrich, St. Louis, Missouri.

Polyethylene terephthalate used was POLYCLEAR® 1101 polyethylene terephthalate having an intrinsic viscosity of 0.83 dL/g, available from Auriga Polymers, Inc. Spartanburg, South Carolina.

DUPONT™ SELAR® PT-X250, DUPONT™ SORONA® 2864 polyesters are available from E. I. DuPont de Nemours and Company, Wilmington, Delaware.

### Intrinsic Viscosity

Intrinsic viscosity (IV) was determined using the Goodyear R-103B Equivalent IV method, using PET T-3, DUPONT™ SELAR® PT-X250, DUPONT™ SORONA® 2864 polyesters as calibration standards on a VISCOTEK® Forced Flow Viscometer Model Y-501C. Methylene chloride was the carrier solvent, and a 50/50 mixture of methylene chloride/trifluoro acetic acid was the polymer solvent. Samples were prepared at 0.4 %(w/v), and shaken overnight at room temperature.

### Interaction Polymer Chromatography (IPC)

IPC was used to monitor the degree of transesterification in a polyester blend and also to characterize chemical composition heterogeneity and microstructure of polyester blends using an Alliance 2690™ chromatography system from Waters Corporation (Milford, Massachusetts), with a Waters PDA UV/Vis spectrometer model 2996 and Evaporative Light Scattering detector ELSD 1000 from Agilent Technologies (US). A NovaPak™ C18 silica-based 4.6 × 150 mm high pressure liquid chromatography (HPLC) column from Waters was used with an H₂O-1,1,1,3,3,3-hexafluoro-2-propanol (HFIP) linear gradient (from 20 to 100% HFIP) mobile phase. Chromatography was run at 35° C., 0.5 mL/min flow rate, with UV spectrum extracted at various wavelengths, using an injection volume of 10 microliters (µL). Data was collected and analyzed with Waters Empower Version 3 software, customized for IPC analyses.

The polymer samples were prepared by dissolution in neat HFIP for at least 4 hours at room temperature with moderate agitation. The polymer sample concentrations are selected to be close to 1 milligram/milliliter. The polymer sample solutions are filtered with 0.45 µm PTFE membrane filter prior to injection into the chromatographic system. Owing to day to day variations in the retention times, relevant homopolymer solutions were run in conjugation with blended samples.

### Transesterification Determination by IPC

The degree of transesterification was determined by an IPC method. This approach allows for separation of complex polymers by polarity (chemistry) of the polymer chains rather than their molecular size, which makes this approach complementary to size exclusion chromatography (SEC). When applied to polymer and/or copolymer blends, IPC separates macromolecules by chemical composition and microstructure, e.g. degree of blockiness. Thus, as shown in Y. Brun, P. Foster, Characterization of Synthetic Copolymers by Interaction Polymer Chromatography: Separation by Microstructure, J. Sep. Sci., 2010, v. 33, pp.3501-351, and herein incorporated in its entirety by reference, the copolymer chains elute between corresponding homopolymer chains, and the retention always increases with degree of blockiness. For example, a statistical A/B (50/50) copolymer elutes later than the alternating copolymer, but before a block-copolymer with same (50/50) composition. When a copolymer sample contains chains with various chemical compositions, the IPC fractionates them by this composition, and in such way reveals chemical composition distribution of the copolymer. Similarly, the estimation of chemical heterogeneity by chain microstructure (blockiness) could be also obtained from the IPC experiments.

An IPC method was developed to separate blends of aromatic and furan-based polyesters by chemistry of the polymer chains to estimate the degree of transesterification in polymer chains. In the extreme case of a polymer blend without any exchange reaction, the resulting IPC trace will produce two peaks corresponding to original homopolymers. In another extreme case of full transesterification, a single narrow peak corresponding to random copolymer will elute in the position between the two homopolymer peaks. The retention time of this peak apex is dependent on the composition of the copolymer and the degree of its blockiness, which could be quantified through the blockiness index (B)-number (see description below). In all intermediate cases of partial transesterification, the IPC chromatogram will be described by a broad multimodal curve, representing fractions of different degrees of transesterification.

### Gas Barrier Testing

Produced samples (bottles) were tested for oxygen (O₂) barrier properties characterized as transmission rate (cubic centimeters (cc) / [package.day.atm] measured at 22° C., 50% relative humidity (RH) external) according to ASTM method F1307. Details of the test conditions are given below:

Oxygen transmission rate testing:
Testing unit: MOCON OX-TRAN® 2/61 (bottles)
Temperature: 22° C.
Environment: 50% RH
Permeant: 100% oxygen

The bottles were tested for carbon dioxide (CO₂) barrier properties characterized as shelf life (weeks at 22° C., 0% RH internal, 50% RH external) according to the FTIR method outlined in US 5,473,161, the entirety of which is incorporated herein by reference. Per widely accepted standards the shelf life was defined as the time for a package to display 21.4% loss of the total initial carbonation charge. The initial carbonation charge target was specified as 4.2 volumes of CO₂ per volume of the package and was delivered via a specific mass of dry ice. Details of the test conditions are given below:

Carbon dioxide shelf life testing:
Temperature: 22° C.
Environment: 50% RH
Permeant: 100% carbon dioxide

### Haze Determination

Haze was determined according to ASTM D-1003. Articles, in this case typically three to five bottles, are measured with a spectrophotometer according to ASTM D-1003. Haze is reported as a percent which represents the amount of scattering of light through a sample; the higher the percent value, the greater the haze, indicating a sample is less transparent.

### Synthesis of Poly(trimethylene-2,5-furandicarboxylate) (PTF)

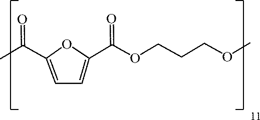

### Step 1: Preparation of PTF Pre-Polymer by Polycondensation of bioPDO™ and FDME

2,5-furandimethylester (27,000 g), 1,3-propanediol (20,084 g), titanium (IV) butoxide (40.8 g), were charged to a 56 liter stainless steel stirred reactor equipped with a stirring rod, agitator, and condenser tower. A nitrogen purge was applied and stirring was commenced at 51 rpm to form a slurry. While stirring, the reactor was subject to a weak nitrogen purge to maintain an inert atmosphere. While the reactor was heated to the set point of 243° C. methanol evolution began at a batch temperature of about 158° C. Methanol distillation continued for 180 minutes (min) during which the temperature increased from 158° C. to 244° C. Following completion of the methanol distillation a vacuum ramp was initiated that reduced the pressure from 760 Torr to 1 Torr over a 120 minute period. The mixture, when at 1 Torr, was left under vacuum and stirring for 150 min, reaching a minimum pressure of 0.56 Torr in addition to periodic reduction in the stirring rate, after which nitrogen was used to pressurize the vessel back to 760 Torr.

The PTF pre-polymer was recovered by pumping the melt through an exit valve at the bottom of the vessel and a six-hole die into a water quench bath. The strands were strung through a pelletizer, equipped with an air jet to remove excess moisture from the strand surface, cutting the polymer strand into pellets. Yield was approximately 21 kg. The PTF pre-polymer had an intrinsic viscosity (IV) of about 0.64 dL/g.

### Step 2: Preparation of PTF Polymer by Solid Phase Polymerization of the PTF Pre-Polymer of Step 1

In order to increase the molecular weight of the PTF pre-polymer, solid phase polymerization was conducted using a large rotating double-cone dryer. Individual batches (~21 kg) of the pelletized PTF pre-polymer were placed in a rotating double-cone dryer, subsequently heating the pellets under a nitrogen purge to about 110° C. for 4 hours (h). Following removal of any fines or overs, batches of the PTF pre-polymer were placed in a large rotating double-cone dryer and the temperature was increased to 165° C. under a flow of heated N₂ to build molecular weight. The batches were held at temperature for either 75 h or 130 h. After the desired time, the oven was turned off and the pellets allowed to cool. The obtained pellets had a measured IV of about 0.79 (75 h) or 0.90 dL/g (130 h). To further increase the molecular weight of the 0.9 dL/g batch, a smaller 14.5 kg sample of the PTF was placed on perforated screens in a convection oven held at 165° C. under a flow of heated N₂ for 147 hours. The oven was turned off and the pellets were allowed to cool. The obtained pellets had a measured intrinsic viscosity of about 1.0 dL/g. A separate batch underwent the same process for extended time in order to achieve a measured intrinsic viscosity of about 1.1 dL/g.

### Preparation of PET/PTF Preforms 1, 2 and 3

POLYCLEAR® 1101 PET was dried overnight under vacuum at 145° C. prior to processing. The PTF polymer was dried overnight under vacuum at 120° C. prior to processing. Dried pellets of PTF and PET were individually weighed out and combined in MYLAR® bags to create blends with 10 wt% PTF prior to injection molding with a specified preform mold. The sample bags were shaken by hand prior to molding to encourage homogeneous mixing of the pellets. For each state the corresponding MYLAR® bag was cut open and secured around the feed throat of an Arburg 420C injection molding machine (available from Arburg GmbH and Co.KG, Loβburg, Germany) to allow for gravimetric feeding. Injection molding of preforms was carried out with a valve-gated hot runner end cap and a 35 millimeter (mm) general purpose screw configuration. The injection molding conditions were optimized to produce acceptable preforms with minimum molded-in stresses and no visual defects per the specified barrel temperatures. Table 1 provides the injection molding conditions employed for each example 1, 2 and 3.

TABLE 1

| | | Preform 1 | Preform 2 | Preform 3 |
|---|---|---|---|---|
| Process Description | | | | |
| | Target preform wt (g) | 25.5 | 18.8 | 25.5 |
| | Mold Temp (°C.) | 12.8 | 12.8 | 12.8 |
| | Dryer Temp (°C.) | 121 | 121 | 127 |
| Barrel Temperature | Feed (°C.) | 281 | 280 | 256 |
| | Zone 2 (°C.) | 280 | 280 | 264 |
| | Zone 3 (°C.) | 280 | 280 | 264 |
| | Zone 4 (°C.) | 280 | 280 | 267 |
| | Nozzle (°C.) | 280 | 280 | 269 |
| Injection | Max Inj. Press. 1 (bar) | 1500 | 1500 | 1500 |
| | 1st Injection Speed (ccm/sec) | 6.0 | 12 | 10.0 |
| | 2nd Injection Speed (ccm/sec) | 4.0 | 10 | 7.5 |
| Holding Pressure | Switch-Over Point (ccm) | 6.0 | 5.0 | 14.0 |
| | 1st Hold Pressure (bar) | 175 | 350 | 200 |
| | 2nd Hold Pressure (bar) | 300 | 350 | 0.0 |
| | 1st Hold Pr. Time (sec) | 1.0 | 0.0 | 17.0 |
| | 2nd Hold Pr. Time (sec) | 30.0 | 14.0 | 0.0 |
| | Plastic Pressure at switch-over (bar) | 260 | 550 | 250 |
| Dosage | Circumference Speed (m/min) | 7.0 | 5.0 | 4.0 |
| | Back Pressure (bar) | 25.0 | 25.0 | 20.0 |
| | Dosage Volume (ccm) | 27.0 | 20.0 | 28.0 |
| | Cushion (ccm) | 2.6 | 2.7 | 4.7 |
| | Measured Dosage Time (sec) | 5.7 | 5.7 | 8.4 |
| Process & Preform Data | Fill Time (sec) | 6.0 | 1.9 | 1.8 |
| | Cooling Time (sec) | 10.0 | 8.0 | 16.0 |
| | Cycle Time (sec) | 50.7 | 27.6 | 39.8 |
| | Actual preform wt (g) | 26.5 | 18.8 | 25.7 |

### Degree of Transesterification

The preforms were analyzed using IPC to determine the degree of transesterification for each sample. IPC results for preform 1 show that 21.6% of the preform is PTF homopolymer, leading to a degree of transesterification of 78.4%. IPC results for preform 2 show that 37% of the preform is PTF homopolymer, leading to a degree of transesterification of 63%. IPC results for preform 3 show that 42.6% of the preform is PTF homopolymer, leading to a degree of transesterification of 57.4%.

### Preparation of PET/PTF Bottles 1, 2 and 3

The preforms used to blow bottles were allowed to equilibrate at ambient temperature and relative humidity for a minimum of 12 hours prior to bottle blowing. The molded preforms were stretch blow molded into 500 milliliter (ml) straight wall bottles under the conditions listed in Table 2, so finalized to allow for optimum weight distribution and consistent sidewall thickness of the obtained bottle for each case. All bottles were blown on a SideI SBO½ lab reheat stretch blow molding machine. The chosen preform design and bottle design determine that the PET/PTF blend experiences directional elongation during bottle blowing described by the stretch ratios found in Table 3. Due to the high natural stretch ratio of PTF, bottle blowing conditions would be expected to deviate significantly from those normally associated with PET. However, it is believed that the use of relatively low levels of the PTF in PET (e.g. up to 20-25 wt%) the process conditions associated both with preform molding and bottle blowing fall within the ranges common for production of PET bottles, as shown in Tables 2 and 3. Bottles with wall thickness and weight distribution comparable to the standard PET bottle were achieved for 10 wt% PTF blends with PET, while preserving the ability to employ preform design, bottle design, injection molding conditions, and bottle blowing conditions common for PET.

TABLE 2

| Example | 1 | 2 | 3 |
|---|---|---|---|
| Speed (bph) | 900 | 1000 | 900 |
| Oven Lamp Settings | | | |
| Overall power (%) | 77 | 70 | 65 |
| Zone 6 | 70 | 85 | 55 |
| Zone 5 | 65 | 85 | 55 |
| Zone 4 | 40 | 100 | 50 |
| Zone 3 | 40 | 10 | 50 |
| Zone 2 | 28 | 0 | 40 |
| Zone 1 | 40 | 85 | 35 |
| Preform Temp. (°C.) | 105 | 97 | 98 |
| Blow Timing/ Pressures | | | |
| Stretch Rod Speed (m/s) | 0.90 | 1.10 | 0.90 |
| Low Blow Position (mm) | 165 | 170 | 160 |
| Low Pressure (bar) | 10.0 | 10.0 | 10.0 |
| Low Blow Flow (bar) | 3 | 3.5 | 3.0 |
| High Blow Position (mm) | 290 | 285 | 275 |
| High Blow Pressure (bar) | 40.0 | 40.0 | 40 |
| Body Mold Temp (°C.) | 7.2 | 7.2 | 7.2 |
| Base Mold Temp. (°C.) | 7.2 | 7.2 | 7.2 |
| Section Weights | | | |
| Top Weight (g) | 8.3 | 6.7 | 8.9 |
| Panel Weight (g) | 5.8 | 3.8 | 5.4 |
| 2nd Panel Weight (g) | 6.2 | 4.4 | 6.1 |
| Base Weight (g) | 6.4 | 4.0 | 5.2 |

TABLE 3

| | | | |
|---|---|---|---|
| Example | 1 | 2 | 3 |
| Target Preform weight (g) | 25.5 | 18.8 | 25.5 |
| Preform wall thickness (mm) | 5.5 | 3.7 | 4.75 |
| Preform inner diameter (mm) | 9.94 | 9.94 | 12.1 |
| Preform working length (mm) | 68.21 | 72.22 | 66.09 |
| Bottle No. | 1 | 2 | 3 |
| Bottle volume (mL) | 500 | 500 | 500 |
| Bottle diameter (mm) | 66.42 | 66.42 | 66.42 |
| Bottle working height (mm) | 177.49 | 177.49 | 177.49 |
| Hoop stretch ratio | 2.60 | 2.46 | 2.69 |
| Axial stretch ratio | 6.68 | 6.68 | 5.49 |
| Areal stretch ratio | 17.39 | 16.42 | 14.74 |

### Comparative Examples: Preparation of 100% PET Bottles

Pellets of POLYCLEAR® 1101 PET were individually weighed out in MYLAR® bags to provide samples of 100 wt% PET in the absence of PTF. These samples were employed to injection mold preforms where the conditions were as specified in Table 4. The corresponding preforms were stretch blow molded into 500 mL bottles under the conditions listed in Table 5, in order to allow for optimum weight distribution and consistent sidewall thickness of the obtained bottle for each state. The preform and bottle mold designs were the same as those in Example 1, producing PET bottles with equivalent stretch ratios to the PET/PTF bottles 1, 2 and 3 described above. The bottle blowing conditions corresponded to those normally associated with PET. Comparative Example C is considered a “standard weight” PET bottle.

TABLE 4

| | Comparative Example | Preform A | Preform B | Preform C | Preform D |
|---|---|---|---|---|---|
| Process Description | | | | | |
| | Target preform wt (g) | 25.5 | 18.8 | 25.5 | 25.5 |
| | Mold Temp (°C.) | 4.4 | 12.8 | 12.8 | 12.8 |
| | Dryer Temp (°C.) | 160 | 127 | 171 | 127 |
| Barrel Temperature | Feed (°C.) | 271 | 279 | 269 | 272 |
| | Zone 2 (°C.) | 274 | 280 | 272 | 270 |
| | Zone 3 (°C.) | 277 | 280 | 269 | 270 |
| | Zone 4 (°C.) | 280 | 280 | 270 | 270 |
| | Nozzle (°C.) | 283 | 280 | 273 | 270 |
| Injection | Max Inj. Press. 1 (bar) | 1500 | 1500 | 1500 | 1500 |
| | 1st Injection Speed (ccm/sec) | 6.0 | 12.0 | 12.0 | 10.0 |
| | 2nd Injection Speed (ccm/sec) | 4.0 | 10.0 | 10.0 | 7.5 |
| Holding Pressure | Switch-Over Point (ccm) | 6.0 | 5.0 | 5.0 | 14.0 |
| | 1st Hold Pressure (bar) | 150.0 | 350.0 | 225.0 | 200.0 |
| | 2nd Hold Pressure (bar) | 250.0 | 350.0 | 225.0 | 0.0 |
| | 1st Hold Pr. Time (sec) | 1.0 | 0.0 | 0 | 17.0 |
| | 2nd Hold Pr. Time (sec) | 30.0 | 14.0 | 12.0 | 0.0 |
| | Plastic Pressure at switch-over (bar) | 340 | 580 | 450 | 280 |
| Dosage | Circumference Speed (m/min) | 6.0 | 5.0 | 4.0 | 4.0 |
| | Back Pressure (bar) | 25.0 | 25.0 | 25.0 | 20.0 |
| | Dosage Volume (ccm) | 27.0 | 20.0 | 25.0 | 28.0 |
| | Cushion (ccm) | 3.5 | 2.8 | 2.7 | 4.7 |
| | Measured Dosage Time (sec) | 6.0 | 5.5 | 8.7 | 8.8 |
| Process & Preform Data | Fill Time (sec) | 6.0 | 1.9 | 2.4 | 1.8 |
| | Cooling Time (sec) | 10.0 | 8.0 | 22.0 | 16.0 |
| | Cycle Time (sec) | 50.7 | 27.6 | 40.1 | 39.7 |
| | Actual preform weight (g) | 26.5 | 18.8 | 25.4 | 25.5 |

TABLE 5

| Comparative Example | A | B | C | D |
|---|---|---|---|---|
| Speed (bph) | 900 | 1000 | 900 | 900 |
| Oven Lamp Settings | | | | |
| Overall power (%) | 78 | 70 | 65 | 65 |
| Zone 6 | 60 | 70 | 50 | 50 |
| Zone 5 | 65 | 70 | 50 | 50 |
| Zone 4 | 40 | 100 | 50 | 50 |
| Zone 3 | 50 | 30 | 50 | 50 |
| Zone 2 | 40 | 0 | 50 | 50 |
| Zone 1 | 40 | 85 | 50 | 50 |
| Preform Temp. (°C.) | 110 | 100 | 104 | 104 |
| Blow Timing/ Pressures | | | | |
| Stretch Rod Speed (m/s) | 0.90 | 1.10 | 0.90 | 0.90 |
| Low Blow Position (mm) | 175 | 180 | 175 | 160 |
| Low Pressure (bar) | 10.0 | 10.0 | 10.0 | 10.0 |
| Low Blow Flow (bar) | 3 | 3 | 3 | 3 |
| High Blow Position (mm) | 290 | 285 | 290 | 275 |
| High Blow Pressure (bar) | 40.0 | 40.0 | 40.0 | 40.0 |
| Body Mold Temp (°C.) | 7.2 | 7.2 | 7.2 | 7.2 |
| Base Mold Temp. (°C.) | 7.2 | 7.2 | 7.2 | 7.2 |
| Section Weights | | | | |
| Top Weight (g) | 8.4 | 6.7 | 9.0 | 9.0 |
| Panel Weight (g) | 5.8 | 3.7 | 5.4 | 5.4 |
| 2nd Panel Weight (g) | 6.6 | 4.4 | 6.0 | 6.0 |
| Base Weight (g) | 5.6 | 4.0 | 4.9 | 4.9 |

The PET/PTF and comparative PET bottles were tested for the ability to provide barrier to oxygen permeation. A minimum of 3 bottles for each state was characterized for oxygen transmission rate. The bottle barrier data is provided in Table 6.

TABLE 6

| Example | bottle weight (g) | Planar stretch ratio | average oxygen permeability (cc/package. day.atm) | % improvement oxygen permeability* | % improvement oxygen permeability^{†} |
|---|---|---|---|---|---|
| Comparative A | 26.5 | 17.4 | 0.1828 | n/a | 1.56 |
| 1 | 26.5 | 17.4 | 0.1386 | 24.15 | 25.33 |
| Comparative B | 18.8 | 16.4 | 0.2553 | n/a | -37.52 |
| 2 | 18.8 | 16.4 | 0.2037 | 20.22 | -9.71 |
| Comparative C | 25.4 | 14.7 | 0.1856 | n/a | n/a |
| Example 3 | 25.4 | 14.7 | 0.1516 | 18.33 | 18.33 |
| Comparative D | 25.4 | 14.7 | 0.1903 | n/a | -2.50 |

* The percent improvement of the oxygen permeability is based on a PET bottle from the same preform design and weight.
† The percent improvement of the oxygen permeability is based on the improvement over Comparative Example C, which is considered to be a standard weight PET bottle.

The% improvement in oxygen permeability is calculated in reference to Comparative Example C, the standard PET bottle (x), and was calculated as follows:

$$\text{\% Improvement =} \frac{\text{P} - {\text{P}}_{\text{PET, x}}}{{\text{P}}_{\text{PET, x}}} \times 100$$

where x is the standard bottle for comparison, P is the average oxygen permeability (cc/package.day.atm) of the bottle, and P_{PET,x} is the average oxygen permeability (cc/package.day.atm) measured for the bottle of Comparative Example C, wherein both the PET/PTF blend bottle and the standard PET bottle are made using the same bottle mold design and have the same volumetric capacity despite changes in total weight as defined by the preform design. The results show that a lighter weight bottle, Example 2, shows an oxygen permeation rate, that is less than or equal to an identically shaped bottle consisting of polyethylene terephthalate polymer and weighing 1.05 to 1.54 times the weight of the PET/PTF bottle. In this case, the bottle of comparative example C weighs 1.35 times the weight of Example 2, while incorporating only 10% PTF. The results also demonstrate that when PET/PTF bottle are compared to identical PET bottles of the same weight, there is provided a percent improvement in the oxygen permeability of 18 to 24%. It can be seen that decreasing the weight of PET/PTF bottles by 5 to 35% over the identical PET bottles would allow for oxygen permeation rates that are less than or equal to the PET bottles.

The PET/PTF and comparative PET bottles were pressure tested with CO₂ to confirm their ability to sustain a minimum pressure of 150 psi. A minimum of 12 bottles for each state was characterized for carbonation loss via the FTIR method (described above) over seven weeks to allow estimation of the carbonated shelf life. The bottle shelf life data is provided in Table 7.

TABLE 7

| Example | Bottle weight (g) | bottle stretch ratio | shelf life (wks)* | steady state CO₂ loss (% CO₂/wk)^{†} | creep / sorption (% CO₂)^{‡} | % improvement shelf life** |
|---|---|---|---|---|---|---|
| Comparative A | 26.5 | 17.4 | 15.1 | 1.33 | 1.33 | 7.70 |
| 1 | 26.5 | 17.4 | 17.98 | 1.12 | 1.18 | 28.2 |
| Comparative B | 18.8 | 16.4 | 10.06 | 1.98 | 1.44 | -28.2 |
| 2 | 18.8 | 16.4 | 13.56 | 1.44 | 1.90 | -3.28 |
| Comparative C | 25.4 | 14.7 | 14.02 | 1.39 | 1.91 | n/a |

* Mean shelf life (weeks) of 12 bottles extrapolated to 21.4% loss at 22° C., 50% RH.
† Determined from slope of linear regression fit to carbonation loss measured with FTIR method.
‡ Determined from y-intercept of linear regression fit to carbonation loss measured with FTIR method.
** As compared to Comparative Example C.

The shelf life data in Table 7 shows that the PET/PTF bottle of Example 2 has a shelf life improvement (comparable to CO₂ permeation rate) that is less than or equal to an identically shaped comparative bottle C, wherein comparative bottle C weighs 1.35x the PET bottle of Example 2. It can be seen from this result that a bottle containing as little as 10% by weight of PTF can result in a lightweight bottle having a CO₂ permeation rate that is equal to or less than the heavier weight bottle consisting of PET.

### Preparation of PET/PTF Preforms 4, 5, 6 and 7

The same process for injection molding preforms as used in the previous example was employed for the following preforms, with the exception that the preforms employed different extruder barrel temperature profiles and in some cases, increased cycle times per preform. The higher temperature state also used increased cycle time per preform to attain approximately equivalent melt residence time to that experienced by the heavier high stretch ratio preform. Finally, the higher temperature states employed a lower molecular weight PTF with a measured IV of 0.79 dL/g. Table 8 provides the injection molding conditions employed for each sample.

TABLE 8

| | | Preform 4 | Preform 5 | Preform 6 | Preform 7 |
|---|---|---|---|---|---|
| Process Description | Polymer Composition | 10% PTF in PET/PTF | | | |
| | Target preform wt (g) | 25.5 | 25.5 | 18.8 | 18.8 |
| | Mold Temp (°C.) | 12.8 | 12.8 | 12.8 | 12.8 |
| | Dryer Temp (°C.) | 121 | 121 | 121 | 121 |
| Barrel Temperature | Feed (°C.) | 280 | 289 | 281 | 290 |
| | Zone 2 (°C.) | 280 | 290 | 279 | 291 |
| | Zone 3 (°C.) | 280 | 289 | 280 | 290 |
| | Zone 4 (°C.) | 280 | 290 | 280 | 290 |
| | Nozzle (°C.) | 280 | 290 | 279 | 290 |
| Injection | Max Inj. Press. 1 (bar) | 1500 | 1500 | 1500 | 1500 |
| | 1st Injection Speed (ccm/sec) | 6.0 | 6.0 | 12 | 12 |
| | 2nd Injection Speed (ccm/sec) | 4.0 | 4.0 | 10 | 10 |
| Holding Pressure | Switch-Over Point (ccm) | 6.0 | 6.0 | 5.7 | 5.7 |
| | 1st Hold Pressure (bar) | 350 | 400 | 350 | 350 |
| | 2nd Hold Pressure (bar) | 350 | 400 | 350 | 350 |
| | 1st Hold Pr. Time (sec) | 1.0 | 1.0 | 0.0 | 0.0 |
| | 2nd Hold Pr. Time (sec) | 29.0 | 31.0 | 14.0 | 14.0 |
| | Plastic Pressure at switch-over (bar) | n/a | 450 | n/a | n/a |
| Dosage | Circumference Speed (m/min) | 8.0 | 8.0 | 5.0 | 5.0 |
| | Back Pressure (bar) | 25.0 | 25.0 | 25.0 | 25.0 |
| | Dosage Volume (ccm) | 27.0 | 27.0 | 20.0 | 20.0 |
| | Cushion (ccm) | 2.5 | 2.4 | 2.5 | 2.6 |
| | Measured Dosage Time (sec) | 7.1 | 4.9 | 5.8 | 5.6 |
| Process & Preform Data | Fill Time (sec) | 6.1 | 6.1 | 1.8 | 1.8 |
| | Cooling Time (sec) | 12.0 | 12.0 | 8.0 | 18.0 |
| | Cycle Time (sec) | 52.4 | 54.4 | 28.5 | 38.2 |
| | Actual preform wt (g) | 26.7 | 26.8 | 18.9 | 19.0 |

### Degree of Transesterification

The preforms were analyzed using IPC to determine the degree of transesterification for each sample. IPC results for preform 4 show that 17.4% of the preform is PTF homopolymer, leading to a degree of transesterification of 82.6%. IPC results for preform 5 show that very little of the preform is PTF homopolymer, leading to a degree of transesterification of about 99.9%. IPC results for preform 6 show that 23.4% of the preform is PTF homopolymer, leading to a degree of transesterification of 76.6%. IPC results for preform 7 show that very little of the preform is PTF homopolymer, leading to a degree of transesterification of about 99.9%.

### Preparation of PET/PTF Bottles 4, 5, 6 and 7

The preforms 4-7 produced above were stretch blow molded according to the process conditions given in Table 9, below. A similar process for reheat stretch blow molding preforms as used in the previous examples was employed herein for these examples. Bottles with weight distribution comparable to the standard PET bottle were achieved for 10 wt% PTF blends with PET while preserving the ability to employ preform design, bottle design, injection molding conditions, and bottle blowing conditions common for PET.

TABLE 9

| Bottle | 4 | 5 | 6 | 7 |
|---|---|---|---|---|
| Sample | Preform 4 | Preform 5 | Preform 6 | Preform 7 |
| Speed (bph) | 900 | 800 | 1000 | 1000 |
| Oven Lamp Settings | | | | |
| Overall power (%) | 82 | 88 | 68 | 68 |
| Zone 6 | 65 | 55 | 75 | 75 |
| Zone 5 | 65 | 75 | 85 | 85 |
| Zone 4 | 40 | 45 | 95 | 75 |
| Zone 3 | 40 | 35 | 10 | 10 |
| Zone 2 | 28 | 20 | 0 | 0 |
| Zone 1 | 40 | 35 | 80 | 70 |
| Preform Temp. (°C.) | 104 | 102 | 97 | 91 |
| Blow Timing/ Pressures | | | | |
| Stretch Rod Speed (m/s) | 0.90 | 0.90 | 1.10 | 1.10 |
| Low Blow Position (mm) | 170 | 170 | 170 | 140 |
| Low Pressure (bar) | 10.0 | 10.0 | 10.0 | 10.0 |
| Low Blow Flow (bar) | 3 | 3 | 3 | 3 |
| High Blow Position (mm) | 285 | 285 | 285 | 285 |
| High Blow Pressure (bar) | 40.0 | 40.0 | 40.0 | 40.0 |
| Body Mold Temp (°C.) | 7.2 | 7.2 | 7.2 | 7.2 |
| Base Mold Temp. (°C.) | 7.2 | 7.2 | 7.2 | 7.2 |
| Section Weights | | | | |
| Top Weight (g) | 8.3 | 8.4 | 6.7 | 6.7 |
| Panel Weight (g) | 5.6 | 5.4 | 3.6 | 3.5 |
| 2nd Panel Weight (g) | 6.1 | 6.6 | 4.4 | 4.6 |
| Base Weight (g) | 6.5 | 6.4 | 4.1 | 4.1 |

### Preparation of Comparative PET Preforms

The same process for injection molding the comparative preforms, and using POLYCLEAR® 1101 PET, as used in the previous comparative examples was employed, with the exception that these injection molded preforms employed two different extruder barrel temperature profiles and in some cases, increased cycle times per preform. These examples employed conditions as specified in Table 10.

TABLE 10

| | | Comparative Preform | | | | |
|---|---|---|---|---|---|---|
| Process Description | | E | F | G | H | I |
| | Target preform wt (g) | 25.5 | 25.5 | 18.8 | 18.8 | 25.5 |
| | Mold Temp (°C.) | 12.8 | 12.8 | 12.8 | 12.8 | 12.8 |
| | Dryer Temp (°C.) | 121 | 121 | 121 | 121 | 121 |
| Barrel Temperature | Feed (°C.) | 280 | 290 | 279 | 290 | 270 |
| | Zone 2 (°C.) | 280 | 290 | 280 | 291 | 275 |
| | Zone 3 (°C.) | 280 | 290 | 280 | 290 | 275 |
| | Zone 4 (°C.) | 280 | 290 | 280 | 290 | 275 |
| | Nozzle (°C.) | 279 | 290 | 280 | 290 | 275 |
| Injection | Max Injection Pressure 1 (bar) | 1500 | 1500 | 1500 | 1500 | 1500 |
| | 1st injection Speed (ccm/sec) | 6.0 | 6.0 | 12.0 | 12.0 | 12.0 |
| | 2nd Injection Speed (ccm/sec) | 4.0 | 4.0 | 10.0 | 10.0 | 10.0 |
| Holding Pressure | Switch-Over Point (ccm) | 6.0 | 6.0 | 5.7 | 5.7 | 5.0 |
| | 1st Hold Pressure (bar) | 350.0 | 350.0 | 350.0 | 350.0 | 250.0 |
| | 2nd Hold Pressure (bar) | 350.0 | 350.0 | 350.0 | 350.0 | 250.0 |
| | 1st Hold Pr. Time (sec) | 0.0 | 0.0 | 0.0 | 0.0 | 0.0 |
| | 2nd Hold Pr. Time (sec) | 29.0 | 29.0 | 14.0 | 14.0 | 13.0 |
| | Plastic Pressure at switch-over (bar) | n/a | n/a | 590 | n/a | 490 |
| Dosage | Circum. Speed (m/min) | 8.0 | 8.0 | 5.0 | 5.0 | 4.0 |
| | Back Pressure (bar) | 25.0 | 25.0 | 25.0 | 25.0 | 25.0 |
| | Dosage Volume (ccm) | 27.0 | 27.0 | 20.0 | 20.0 | 25.0 |
| | Cushion (ccm) | 2.6 | 2.6 | 3.2 | 2.6 | 1.9 |
| | Meas. Dosage Time (sec) | 7.6 | 4.9 | 5.3 | 5.7 | 9.7 |
| Process & Preform Data | Fill Time (sec) | 6.1 | 6.1 | 1.8 | 1.8 | 2.4 |
| | Cooling Time (sec) | 12.0 | 12.0 | 8.0 | 16.5 | 21.0 |
| | Cycle Time (sec) | 52.4 | 52.4 | 28.5 | 36.9 | 40.3 |
| | Actual preform wt (g) | 26.6 | 26.6 | 18.9 | 18.9 | 25.3 |

### Preparation of Comparative PET Bottles E, F, G, H and I

A similar process for reheat stretch blow molding the comparative preforms as was used in the previous examples was employed for the comparative bottles and shown in Table 11. The bottle blowing conditions corresponded to those normally associated with PET.

TABLE 11

| Comparative Bottle | E | F | G | H | I |
|---|---|---|---|---|---|
| Speed (bph) | 900 | 800 | 1000 | 1000 | 900 |
| Oven Lamp Settings | | | | | |
| Overall power (%) | 76 | 70 | 70 | 70 | 65 |
| Zone 6 | 60 | 55 | 75 | 75 | 50 |
| Zone 5 | 65 | 60 | 70 | 70 | 50 |
| Zone 4 | 40 | 40 | 100 | 100 | 50 |
| Zone 3 | 50 | 47 | 30 | 30 | 50 |
| Zone 2 | 40 | 37 | 0 | 0 | 50 |
| Zone 1 | 40 | 40 | 80 | 80 | 50 |
| Preform Temp. (°C.) | 106 | 103 | 101 | 102 | 98 |
| Blow Timing/ Pressures | | | | | |
| Stretch Rod Speed (m/s) | 0.90 | 0.90 | 1.10 | 1.10 | 0.90 |
| Low Blow Position (mm) | 170 | 170 | 180 | 170 | 175 |
| Low Pressure (bar) | 10.0 | 10.0 | 10.0 | 10.0 | 10.0 |
| Low Blow Flow (bar) | 3 | 3 | 3 | 3 | 3 |
| High Blow Position (mm) | 285 | 285 | 285 | 285 | 285 |
| High Blow Pressure (bar) | 40.0 | 40.0 | 40.0 | 40.0 | 40.0 |
| Body Mold Temp (°C.) | 7.2 | 7.2 | 7.2 | 7.2 | 7.2 |
| Base Mold Temp. (°C.) | 7.2 | 7.2 | 7.2 | 7.2 | 7.2 |
| Section Weights | | | | | |
| Top Weight (g) | 8.6 | 8.6 | 6.8 | 6.7 | 8.9 |
| Panel Weight (g) | 5.9 | 5.9 | 3.6 | 3.6 | 5.5 |
| 2nd Panel Weight (g) | 6.8 | 6.5 | 4.5 | 4.4 | 6.2 |
| Base Weight (g) | 5.3 | 5.5 | 3.8 | 4.0 | 4.8 |

The bottles 4-7 and Comparative bottles E-I had the following measured parameters shown in Table 12.

TABLE 12

| Bottle | 4,5,E F | 6, 7, G, H | I |
|---|---|---|---|
| Preform No. | 123 | 124 | 125 |
| Finish Type | 1810 | 1881 | 1810 |
| Target Preform weight (g) | 25.5 | 18.8 | 25.5 |
| Preform wall thickness (mm) | 5.5 | 3.7 | 4.75 |
| Preform inner diameter (mm) | 9.94 | 9.94 | 12.1 |
| Preform working length (mm) | 68.21 | 72.22 | 66.09 |
| Bottle No. | CT-4858 | CT-4858 | CT-4858 |
| Bottle volume (mL) | 500 | 500 | 500 |
| Bottle diameter (mm) | 66.42 | 66.42 | 66.42 |
| Bottle working height (mm) | 177.49 | 177.49 | 177.49 |
| Hoop stretch ratio | 2.60 | 2.46 | 2.69 |
| Axial stretch ratio | 6.68 | 6.68 | 5.49 |
| Planar stretch ratio | 17.39 | 16.42 | 14.74 |

### Gas Barrier Testing for Bottle 4-7 and Comparative Bottles E-I

The produced PET/PTF blend bottles and PET bottles were tested for the ability to provide barrier to oxygen permeation. A minimum of 3 bottles for each state was characterized for oxygen transmission rate. The bottle oxygen transmission rate data is provided in Table 13.

TABLE 13

| Example | bottle weight (g) | Planar stretch ratio | Minimum extruder temp. (°C.) | Maximum extruder temp. (°C.) | *Melt residence time (s) | Pₓ, avg. oxygen permeability (cc/package. day.atm) | % improvement oxygen permeability* | % improvement oxygen permeability^{†} |
|---|---|---|---|---|---|---|---|---|
| E | 26.5 | 17.4 | 279 | 280 | 274 | 0.1796 | n/a | -6.02 |
| F | 26.5 | 17.4 | 290 | 290 | 274 | 0.1661 | n/a | 1.95 |
| 4 | 26.5 | 17.4 | 280 | 280 | 275 | 0.1465 | 18.41 | 13.50 |
| 5 | 26.5 | 17.4 | 289 | 290 | 285 | 0.1540 | 7.30 | 9.11 |
| G | 18.8 | 16.4 | 279 | 280 | 201 | 0.2626 | n/a | -55.02 |
| H | 18.8 | 16.4 | 290 | 291 | 261 | 0.2513 | n/a | -48.34 |
| 6 | 18.8 | 16.4 | 279 | 281 | 202 | 0.2069 | 21.23 | -22.11 |
| 7 | 18.8 | 16.4 | 290 | 291 | 270 | 0.2067 | 17.74 | -22.02 |
| I | 25.4 | 14.7 | 270 | 275 | 229 | 0.1694 | n/a | n/a |

* The percent improvement of the oxygen permeability is based on a PET bottle from the same preform design and weight.
† The percent improvement of the oxygen permeability is based on the improvement over Comparative Example l, which is considered to be a standard size PET bottle.

The melt residence time is estimated per preform and composition based on the necessary dosage volume, cushion, screw volume and total cycle time to produce one preform. The results in Table 13 demonstrate that when PET/PTF bottle are compared to identical PET bottles of the same the same weight, there is provided a percent improvement in the oxygen permeability of 7 to 21%. It can be seen that decreasing the weight of PET/PTF bottles by 5 to 35% over the identical PET bottles would allow for oxygen permeation rates that are less than or equal to the PET bottles.

### Preparation of PET/PTF Preforms 8, 9, 10, 11, 12 and 13

The same process for injection molding preforms as used in the previous example was employed for the following preforms, with the following exceptions. Barrel temperature profiles were either 270° C. or 280° C. The percent PTF was defined at 10, 15, or 20% weight of the blend. The measured IV of the PTF used was 0.62, 0.86, or 1.09 dL/g. The cycle time per preform was set to attain approximately equivalent melt residence time for all states. Table 14 provides the injection molding conditions employed for each sample.

TABLE 14

| | | Preform 8 | Preform 9 | Preform 10 | Preform 11 | Preform 12 | Preform 13 |
|---|---|---|---|---|---|---|---|
| Process Description | Polymer Composition | 10% PTF in PET/PTF | 10% PTF in PET/PTF | 10% PTF in PET/PTF | 15% PTF in PET/PTF | 20% PTF in PET/PTF | 20% PTF in PET/PTF |
| | PTF IV (dL/g) | 0.62 | 1.09 | 0.86 | 0.86 | 0.62 | 1.09 |
| | Target preform wt (g) | 18.8 | 18.8 | 18.8 | 18.8 | 18.8 | 18.8 |
| | Mold Temp (°C.) | 12.8 | 12.8 | 12.8 | 12.8 | 12.8 | 12.8 |
| | Dryer Temp (°C.) | 121 | 121 | 121 | 121 | 121 | 121 |
| Barrel Temperature | Feed (°C.) | 270 | 270 | 280 | 280 | 270 | 270 |
| | Zone 2 (°C.) | 270 | 270 | 280 | 280 | 270 | 270 |
| | Zone 3 (°C.) | 270 | 270 | 280 | 280 | 270 | 270 |
| | Zone 4 (°C.) | 270 | 270 | 280 | 280 | 269 | 270 |
| | Nozzle (°C.) | 270 | 270 | 280 | 280 | 270 | 270 |
| Injection | Max Inj. Press. 1 (bar) | 1500 | 1500 | 1500 | 1500 | 1500 | 1500 |
| | 1st Injection Speed (ccm/sec) | 12.0 | 12.0 | 12.0 | 12.0 | 12.0 | 12.0 |
| | 2nd Injection Speed (ccm/sec) | 10.0 | 10.0 | 10.0 | 10.0 | 10.0 | 10.0 |
| Holding Pressure | Switch-Over Point (ccm) | 4.0 | 4.0 | 4.0 | 4.0 | 4.0 | 4.0 |
| | 1st Hold Pressure (bar) | 325.0 | 325.0 | 325.0 | 325.0 | 325.0 | 325.0 |
| | 2nd Hold Pressure (bar) | 325.0 | 325.0 | 325.0 | 325.0 | 325.0 | 325.0 |
| | 1st Hold Pr. Time (sec) | 0.0 | 0.0 | 0.0 | 0.0 | 0.0 | 0.0 |
| | 2nd Hold Pr. Time (sec) | 9.0 | 9.0 | 9.0 | 9.0 | 9.0 | 9.0 |
| | Plastic Pressure at switch-over (bar) | 410 | 480 | 370 | 350 | 380 | 450 |
| Dosage | Circumferen ce Speed (m/min) | 5.0 | 5.0 | 5.0 | 5.0 | 5.0 | 5.0 |
| | Back Pressure (bar) | 25.0 | 25.0 | 25.0 | 25.0 | 25.0 | 25.0 |
| | Dosage Volume (ccm) | 20.0 | 20.0 | 20.0 | 20.0 | 20.0 | 20.0 |
| | Cushion (ccm) | 2.7 | 2.6 | 2.5 | 2.4 | 2.4 | 2.6 |
| | Measured Dosage Time (sec) | 5.6 | 5.6 | 5.7 | 5.6 | 5.8 | 5.6 |
| Process & Preform Data | Fill Time (sec) | 2.1 | 2.0 | 2.0 | 2.1 | 2.0 | 2.0 |
| | Cooling Time (sec) | 11.0 | 11.0 | 11.0 | 11.0 | 11.0 | 11.0 |
| | Cycle Time (sec) | 26.0 | 26.0 | 26.0 | 26.0 | 26.0 | 26.0 |
| | Actual preform wt (g) | 18.8 | 18.8 | 18.8 | 18.9 | 18.9 | 18.9 |

### Degree of Transesterification

The preforms were analyzed using IPC to determine the degree of transesterification for each sample. IPC results for preform 8 show that 10.5% of the preform is PTF homopolymer, leading to a degree of transesterification of 89.5%. IPC results for preform 9 show that 3.9% of the preform is PTF homopolymer, leading to a degree of transesterification of 96.1%. IPC results for preforms 10, 11, 12, and 13 show that very little of the preform is PTF homopolymer, leading to a degree of transesterification for each preform of about 100%.

### Preparation of PET/PTF Bottles 8, 9, 10, 11, 12 and 13

The preforms 8-13 produced above were stretch blow molded according to the process conditions given in Table 15, below. A similar process for reheat stretch blow molding preforms as used in the previous examples was employed herein for these examples. Bottles with weight distribution comparable to the lightweight PET bottle (Comparative bottle K) were achieved for 10, 15, and 20 wt% PTF blends with PET while preserving the ability to employ preform design, bottle design, injection molding conditions, and bottle blowing conditions common for PET.

TABLE 15

| Bottle | 8 | 9 | 10 | 11 | 12 | 13 |
|---|---|---|---|---|---|---|
| Sample | Preform 8 | Preform 9 | Preform 10 | Preform 11 | Preform 12 | Preform 13 |
| Speed (bph) | 1000 | 1000 | 1000 | 1000 | 1000 | 1000 |

| | | | | | | |
|---|---|---|---|---|---|---|
| Oven Lamp Settings | | | | | | |
| Overall power (%) | 68 | 75 | 75 | 65 | 60 | 60 |
| Zone 6 | 55 | 60 | 70 | 65 | 70 | 80 |
| Zone 5 | 55 | 70 | 70 | 55 | 65 | 80 |
| Zone 4 | 100 | 100 | 80 | 90 | 85 | 85 |
| Zone 3 | 30 | 10 | 10 | 10 | 20 | 15 |
| Zone 2 | 0 | 0 | 0 | 0 | 0 | 0 |
| Zone 1 | 70 | 74 | 74 | 60 | 55 | 65 |
| Preform Temp. (°C) | 73 | 78 | 70 | 68 | 71 | 70 |

| Blow Timing/ Pressures | | | | | | |
|---|---|---|---|---|---|---|
| Stretch Rod Speed (m/s) | 1.10 | 1.10 | 1.10 | 0.70 | 0.50 | 1.00 |
| Low Blow Position (mm) | 180 | 180 | 180 | 140 | 120 | 180 |
| Low Pressure (bar) | 10.0 | 10.0 | 10.0 | 10.0 | 6.5 | 10.0 |
| Low Blow Flow (bar) | 3 | 3 | 3 | 3 | 7 | 3 |
| High Blow Position (mm) | 285 | 285 | 285 | 285 | 285 | 285 |
| High Blow Pressure (bar) | 40.0 | 40.0 | 40.0 | 40.0 | 40.0 | 40.0 |
| Body Mold Temp (°C.) | 7.2 | 7.2 | 7.2 | 7.2 | 7.2 | 7.2 |
| Base Mold Temp. (°C.) | 7.2 | 7.2 | 7.2 | 7.2 | 7.2 | 7.2 |
| Section Weights | | | | | | |
| Top Weight (g) | 6.7 | 6.6 | 6.6 | 6.7 | 6.8 | 6.7 |
| Panel Weight (g) | 3.3 | 3.1 | 3.0 | 3.0 | 2.7 | 2.9 |
| 2nd Panel Weight (g) | 3.9 | 4.0 | 4.1 | 4.0 | 3.9 | 4.2 |
| Base Weight (g) | 5.0 | 4.9 | 5.1 | 5.0 | 5.3 | 5.1 |

### Preparation of Comparative PET Preforms

The same process for injection molding the comparative preforms, and using POLYCLEAR® 1101 PET, as used in the previous comparative examples was employed. These examples employed conditions as specified in Table 16.

TABLE 16

| | | Comparative Preform | |
|---|---|---|---|
| Process Description | | J | K |
| | Target preform wt (g) | 25.5 | 18.8 |
| | Mold Temp (°C.) | 12.8 | 12.8 |
| | Dryer Temp (°C.) | 121 | 121 |
| Barrel Temperature | Feed (°C.) | 280 | 279 |
| | Zone 2 (°C.) | 280 | 280 |
| | Zone 3 (°C.) | 280 | 280 |
| | Zone 4 (°C.) | 280 | 280 |
| | Nozzle (°C.) | 280 | 280 |
| Injection | Max Injection Pressure 1 (bar) | 750 | 1500 |
| | 1st Injection Speed (ccm/sec) | 12.0 | 12.0 |
| | 2nd Injection Speed (ccm/sec) | 10.0 | 10.0 |
| Holding Pressure | Switch-Over Point (ccm) | 4.5 | 4.0 |
| | 1st Hold Pressure (bar) | 225.0 | 325.0 |
| | 2nd Hold Pressure (bar) | 225.0 | 325.0 |
| | 1st Hold Pr. Time (sec) | 0.0 | 0.0 |
| | 2nd Hold Pr. Time (sec) | 15.0 | 9.0 |
| | Plastic Pressure at switch-over (bar) | 300 | 420 |
| Dosage | Circum. Speed (m/min) | 4.0 | 5.0 |
| | Back Pressure (bar) | 25.0 | 25.0 |
| | Dosage Volume (ccm) | 25.0 | 20.0 |
| | Cushion (ccm) | 1.4 | 2.5 |
| | Meas. Dosage Time (sec) | 10.2 | 5.8 |
| Process & Preform Data | Fill Time (sec) | 2.5 | 2.1 |
| | Cooling Time (sec) | 18.0 | 11.0 |
| | Cycle Time (sec) | 39.4 | 26.0 |
| | Actual preform wt (g) | 25.4 | 18.8 |

### Preparation of Comparative PET Bottles J and K

A similar process for reheat stretch blow molding the comparative preforms as was used in the previous examples was employed for the comparative bottles and shown in Table 17. The bottle blowing conditions corresponded to those normally associated with PET.

TABLE 17

| Comparative Bottle | J | K |
|---|---|---|
| Speed (bph) | 900 | 1000 |
| Oven Lamp Settings | | |
| Overall power (%) | 67 | 75 |
| Zone 6 | 30 | 70 |
| Zone 5 | 50 | 70 |
| Zone 4 | 70 | 50 |
| Zone 3 | 50 | 30 |
| Zone 2 | 40 | 20 |
| Zone 1 | 67 | 70 |
| Preform Temp. (°C.) | 91 | 80 |
| Blow Timing/ Pressures | | |
| Stretch Rod Speed (m/s) | 0.90 | 1.10 |
| Low Blow Position (mm) | 175 | 180 |
| Low Pressure (bar) | 10 | 10.0 |
| Low Blow Flow (bar) | 3 | 3 |
| High Blow Position (mm) | 285 | 285 |
| High Blow Pressure (bar) | 40 | 40.0 |
| Body Mold Temp (°C.) | 7.2 | 7.2 |
| Base Mold Temp. (°C.) | 7.2 | 7.2 |
| Section Weights | | |
| Top Weight (g) | 8.7 | 6.7 |
| Panel Weight (g) | 5.6 | 3.1 |
| 2nd Panel Weight (g) | 6.2 | 4.1 |
| Base Weight (g) | 4.9 | 5.0 |

The bottles 8-13 and Comparative bottles J-K had the following measured parameters shown in Table 18.

TABLE 18

| Bottle | 8, 9, 10, 11, 12, 13, K | J |
|---|---|---|
| Preform No. | 124 | 125 |
| Finish Type | 1881 | 1810 |
| Target Preform weight (g) | 18.8 | 25.5 |
| Preform wall thickness (mm) | 3.7 | 4.75 |
| Preform inner diameter (mm) | 9.94 | 12.1 |
| Preform working length (mm) | 72.22 | 66.09 |
| Bottle No. | CT-4858 | CT-4858 |
| Bottle volume (mL) | 500 | 500 |
| Bottle diameter (mm) | 66.42 | 66.42 |
| Bottle working height (mm) | 177.49 | 177.49 |
| Hoop stretch ratio | 2.46 | 2.69 |
| Axial stretch ratio | 6.68 | 5.49 |
| Planar stretch ratio | 16.42 | 14.74 |

### Gas Barrier Testing for Bottles 8-13 and Comparative Bottles J-K

The produced PET/PTF blend bottles and PET bottles were tested for the ability to provide barrier to oxygen permeation. A minimum of 3 bottles for each state was characterized for oxygen transmission rate. The bottle oxygen transmission rate data is provided in Table 19.

TABLE 19

| Ex. | bottle weight (g) | Planar stretch ratio | Extruder temp. (°C.) | *Melt residence time (s) | PTF in PET/PTF (%) | PTF IV (dL/g) | Pₓ, avg. oxygen permeability (cc/package. day.atm) | % improve oxygen permeability | % improvement oxygen permeability^{†} |
|---|---|---|---|---|---|---|---|---|---|
| 8 | 18.8 | 16.4 | 270 | 184 | 10 | 0.62 | 0.2430 | 12.17 | -21.06 |
| 9 | 18.8 | 16.4 | 270 | 184 | 10 | 1.09 | 0.2150 | 22.27 | -7.13 |
| 10 | 18.8 | 16.4 | 280 | 184 | 10 | 0.86 | 0.2124 | 23.23 | -5.80 |
| 11 | 18.8 | 16.4 | 280 | 184 | 15 | 0.86 | 0.2085 | 24.63 | -3.88 |
| 12 | 18.8 | 16.4 | 270 | 184 | 20 | 0.62 | 0.2167 | 21.67 | -7.96 |
| 13 | 18.8 | 16.4 | 270 | 184 | 20 | 1.09 | 0.1999 | 27.75 | 0.43 |
| K | 18.8 | 16.4 | 280 | 184 | 0 | n/a | 0.2766 | n/a | -37.82 |
| J | 25.4 | 14.7 | 280 | 225 | 0 | n/a | 0.2007 | n/a | n/a |

* The percent improvement of the oxygen permeability is based on a PET bottle from the same preform design and weight.
† The percent improvement of the oxygen permeability is based on the improvement over Comparative Example J, which is considered to be a standard size PET bottle.

The melt residence time is estimated per preform and composition based on the necessary dosage volume, cushion, screw volume and total cycle time to produce one preform. The results in Table 19 demonstrate that when PET/PTF bottle are compared to identical PET bottles of the same the same weight, there is provided a percent improvement in the oxygen permeability of 12 to 28%. It can be seen that decreasing the weight of PET/PTF bottles by 5 to 50 wt% over the identical PET bottles would allow for oxygen permeation rates that are less than or equal to the PET bottles.

1. A process for reducing the weight of a polyethylene terephthalate (PET) bottle comprising:
a) replacing in the range of from 5% to 30% by weight of the polyethylene terephthalate with polytrimethylene furandicarboxylate (PTF) to provide a PET/PTF bottle;
wherein the PET/PTF bottle has an oxygen permeation rate, a carbon dioxide permeation rate and/or a water vapor permeation rate that is less than or equal to an identically shaped bottle consisting of polyethylene terephthalate polymer and weighing 1.05 to 2.00 times the weight of the PET/PTF bottle;
wherein the polyethylene terephthalate and the polytrimethylene furandicarboxylate has a degree of transesterification ranging from 50 to 100%, and
wherein the bottle has an areal stretch ratio in the range of from 12 to 30.

2. A process for reducing the weight of a polyethylene terephthalate (PET) bottle comprising:
a) blowing a preform to form a PET/PTF bottle;
wherein the preform comprises in the range of 70% to 95% by weight of polyethylene
terephthalate and 5% to 30% by weight of polytrimethylene furandicarboxylate;
wherein the PET/PTF bottle has a degree of transesterification in the range of from 50 to 100% between the polyethylene terephthalate and the Polytrimethylene furandicarboxylate;
wherein the PET/PTF bottle has an oxygen permeation rate, a carbon dioxide permeation rate and/or a water vapor permeation rate of less than or equal to an identically shaped bottle consisting of PET polymer that has a weight that is 1.05 to 1.54 times the weight of the PET/PTF bottle; and
wherein the PET/PTF bottle has an areal stretch ratio in the range of from 12 to 30.

3. The process of claim 1 wherein the amount of polytrimethylene furandicarboxylate is in the range of from 5 to 15% by weight, based on the total amount of polyethylene terephthalate and polytrimethylene furandicarboxylate.

4. The process of claim 1 wherein the PET/PTF bottle has an areal stretch ratio in the range of from 12 to 20.

5. The process of claim 1 wherein the degree of transesterification is in the range of from 70 to 100%.

6. The process of claim 1 wherein the Polytrimethylene furandicarboxylate comprises a titanium alkoxide catalyst and the polyethylene terephthalate comprises an antimony catalyst.

7. The process of claim 1 wherein the bottle comprises a continuous phase of the polyethylene terephthalate and a discontinuous phase of the polytrimethylene furandicarboxylate, or wherein the bottle comprises a substantially continuous phase of the polyethylene terephthalate and the Polytrimethylene furandicarboxylate.

8. The process of claim 1 wherein the Polytrimethylene furandicarboxylate has a weight average molecular weight in the range of from 150 to 300,000 Daltons.

9. The process of claim 1 wherein the PET/PTF bottle is a monolayer bottle or wherein the PET/PTF bottle is a multilayer bottle.

10. The process of claim 1 further comprising filling the PET/PTF bottle with a product selected from food, a personal care product, a pharmaceutical product, a household product, or an industrial product.

11. A process comprising:
a) heating a mixture comprising 5% to 30% by weight of polytrimethylene furandicarboxylate and 70% to 95% by weight of polyethylene terephthalate to form a polymer melt, wherein the percentages by weight are based on the total weight of the polymer melt; and
b) forming a preform from the melt, wherein: the polyethylene terephthalate and the polytrimethylene furandicarboxylate in the preform has a degree of transesterification ranging from 50 to 100%.

12. The process of claim 11 further comprising:
c) blowing the preform to form a PET/PTF bottle,
wherein the PET/PTF bottle has an areal stretch ratio in the range of from 12 to 30.

13. The process of claim 12 wherein the PET/PTF bottle has an areal stretch ratio in the range of from 12 to 20.

14. The process of claim 12 wherein the PET/PTF bottle has an oxygen permeation rate or a carbon dioxide permeation rate that is less than or equal to an identically shaped bottle consisting of PET polymer that weighs 1.05 to 1.54 times the weight of the PET/PTF bottle.

15. The process of claim 11 wherein the mixture comprises particles of polyethylene terephthalate and particles of polytrimethylene furandicarboxylate.

16. The process of claim 11 wherein the degree of transesterification of the preform is in the range of from 70 to 100%.

17. The process of claim 11 wherein the polytrimethylene furandicarboxylate comprises a titanium alkoxide and the polyethylene terephthalate comprises antimony.

18. The process of claim 11 wherein the preform comprises a continuous phase of polyethylene terephthalate and a discontinuous phase of polytrimethylene furandicarboxylate, or wherein the preform comprises a substantially continuous phase of the polyethylene terephthalate and the polytrimethylene furandicarboxylate.

19. The process of claim 11 wherein the polytrimethylene furandicarboxylate has a weight average molecular weight in the range of from 150 to 300,000 Daltons.

20. The process of claim 11 wherein the preform is a single layer preform or wherein the preform is a multi layered preform comprising two or more layers.

21-22. (canceled)
